(19) United States
(12) Patent Application Publication
(10) Pub. No.: US 2025/0363508 A1
(43) Pub. Date: Nov. 27, 2025

(54) DISPLAY DEVICE CONTROL

(71) Applicant: S&P Global Inc., New York, NY (US)

(72) Inventors: Sasmita Dhal, Newport, NJ (US); Vinay Kumar Arle, Hyderabad (IN); Shubham Sharma, Gurgaon (IN); Sailaskhmi Priyanka Vunnam, Hyderabad (IN); Saransh Shukla, Hyderabad (IN); Srinivas Meda, Morristown, NJ (US); Vardhani Paruchuri, Monroe Township, NJ (US); Duy Ho, London (GB); Christopher Ewen, London (GB)

(21) Appl. No.: 18/674,552

(22) Filed: May 24, 2024

(51) Int. Cl. G06Q 30/0201; G06F 3/0482; G06Q 40/04

(52) U.S. Cl. CPC G06Q 30/0201; G06F 3/0482; G06Q 40/04

(57) ABSTRACT

A process and machine and computer program code for controlling a display of dynamic data updates is provided. The process may include a graphical user interface receiving transaction data for the event in a variance input resolver from a first transaction device and a second transaction device and dynamically displaying the transaction data received and formatted by an input variance resolver into a first region as a function of time. The machine and process may identify a selected market and a time period and display, dependent upon the first region, a selected market and a time period, a second region and a fourth region of the graphical user interface; and displaying, dependent upon the second region, a third region on the graphical user interface.

### CROSS-REFERENCE TO RELATED APPLICATIONS

This application is related to the following U.S. Patent Applications entitled “Display Screen with a Transitional Graphical User Interface” Ser. No. 29/879,002, attorney docket no. SPG-CI-2023-06-02-1-D, filed Jun. 30, 2023, assigned to the same assignee, and incorporated herein by reference, and “Display Screen with a Graphical User Interface,” Ser. No. 29/911,234, attorney docket no. SPG-CI-2023-06-02-2-D, filed Aug. 30, 2023, also assigned to the same assignee, and incorporated herein by reference.

### BACKGROUND

### 1. Field

The disclosure relates generally to an improved computer system and, more specifically, to a process and/or machine—a computer system, and computer program product for controlling the display of dynamic data. More particularly, the disclosure relates to a computer system and graphical user interface for visibly displaying transaction data variances and trends.

### 2. Description of the Related Art

Processing massive data transactions in a useful format in real time is known to be challenging. Massive data transactions may be a number of data transactions that exceed 30 million per day.

A greater challenge exists in attempting to direct an action based upon massive data transactions when some of the data anticipated to direct an action is absent. Further still, a challenge exists to visualize guardrails to guidelines that direct actions based upon the massive data transactions that highlight parts of the massive data that may be classified as unusual and/or violate the guidelines that direct actions based upon the massive data transactions. One of ordinary skill in the art recognizes the technological improvement in reducing processing time and improving accuracy for a directed action when a potential violation of a guideline for a data transaction value in a massive number of data transactions may be: recognized, visualized, and/or excluded in real time from being used as a basis for directing an action and/or a visualization for the massive data transactions.

Therefore, it would be desirable to have a process and apparatus that take into account at least some of the issues discussed above, as well as other possible issues. For example, it would be desirable to provide a process and/or a user interface that allows for easier visualization of massive amounts of data transactions and trends. Likewise, it would be desirable to have a process and/or a machine—a computer system, and computer program product that provides a visualization that increases a comprehension and speed at which information, such as dynamic data, can be accessed and comprehended and/or direct an action, as compared with using current systems.

### SUMMARY

According to one embodiment of the present invention, a process provides for controlling a display of dynamic data updates. The process may include displaying an event on a graphical user interface. The process may include: receiving transaction data for the event in an input variance resolver from a first transaction device and a second transaction device; dynamically displaying the transaction data received by an input variance resolver in a first region of the graphical user interface, wherein transaction data received from the first transaction device are separately displayed from the transaction data received from the second transaction device as distinct columns as a function of time; identifying a selected market from a list of subscribed markets displayed in the first region of the graphical user interface; identifying a time period for the selected market; displaying, dependent upon the selected market and the time period, a second region of the graphical user interface; and displaying, dependent upon the second region, a third region on the graphical user interface.

The process may also include identifying a selected market from a list of subscribed markets displayed in a first region of the graphical user interface and identifying a time period for the selected market by the input variance resolver receiving a selection of a cell within the first region. The process may also include
displaying a range of time periods in the first region of
the graphical user interface; receiving a selection of a
specific time period displayed; and in response to the selection of the specific time period, dynamically updating the first region to display a subset of market participants that are active within the specific time period.

The process for displaying an event on a graphical user interface may further include receiving a selection of a first column of transaction data for the first transaction device, selected from the first region of the graphical user interface. The process may also include dynamically generating the second region using a selected cell from the first region. The process may also include
displaying a first indicator in the third region indicating that the first transaction device has consummated a trade.

The process for displaying an event on a graphical user interface may further include displaying, using the second region, a guardrail in the third region. The process may also include the input variance resolver receiving a selection of a cell in the first region of the graphical user interface; and dynamically determining a spread within any of the transaction data associated with the cell. The process may also include the input variance resolver receiving a selection of a cell in the first region of the graphical user interface; and dynamically determining a normalization value for the transaction data associated with the cell.

The process for displaying an event on a graphical user interface may further include the input variance resolver determining a guardrail for transaction data associated with a cell; and an alert rule communicating an alert when received data transaction for a cell contain data outside a guardrail. The process may also include registering the alert rule with a server-side rules engine.

The process may also include displaying, using the first region and the third region, a fourth region on the graphic user interface.

According to another embodiment of the present invention, a computer system configured to control a display of dynamic data updates may include: a hardware processor; a display system that comprises a graphical user interface; and an input variance resolver. The input variance resolver may be configured to: communicate with the hardware processor and the display system; and control a display on a graphical user interface. The input variance resolver may be further configured to: receive transaction data from a first transaction device and a second transaction device; dynamically display the transaction data received by an input variance resolver in a first region of the graphical user interface, wherein transaction data received from the first transaction device are separately displayed from the transaction data received from the second transaction device as distinct columns as a function of time; identify a selected market from a list of subscribed markets displayed in a first region of the graphical user interface; identify a time period for the selected market; display, dependent upon the selected market and the time period, a second region of the graphical user interface; and display, dependent upon the second region, a third region on the graphical user interface.

The input variance resolver may be further configured to identify a selected market from a list of subscribed markets displayed in a first region of the graphical user interface and identifying a time period for the selected market by the input variance resolver receiving a selection of a cell within the first region. The input variance resolver may be further configured to display a range of time periods in the first region of the graphical user interface; receive a selection of a specific time period displayed; and in response to the selection of the specific time period, dynamically update the first region to display a subset of market participants that are active within the specific time period.

The input variance resolver in a computer system configured to control a display of dynamic data updates may also be further configured to receive a selection of a first column of transaction data for the first transaction device, selected from the first region of the graphical user interface. The input variance resolver may be further configured to dynamically generate the second region using a selected cell from the first region. The input variance resolver may be further configured to display a first indicator in the third region indicating that the first transaction device has consummated a trade. The input variance resolver may also be further configured to
to display, based upon the second region, a guardrail in the third region.

According to yet another embodiment of the present invention, a computer program product for controlling a display of dynamic data updates may include: a computer readable storage media; and program code, stored on the computer readable storage media. The program code may be configured to display an event on a graphical user interface, and: receive transaction data from a first transaction device and a second transaction device; dynamically display the transaction data received by an input variance resolver in a first region of the graphical user interface, wherein transaction data received from the first transaction device are separately displayed from the transaction data received from the second transaction device as distinct columns as a function of time. The program code may also be configured to identify a selected market from a list of subscribed markets displayed in a first region of the graphical user interface; identify a time period for the selected market; display, dependent upon the selected market and the time period, a second region of the graphical user interface; and display, dependent upon the second region, a third region on the graphical user interface.

### BRIEF DESCRIPTION OF THE DRAWINGS

FIG. 1 is a pictorial representation of a network of data processing systems in which illustrative embodiments may be implemented;

FIG. 2 is a block diagram of an application environment depicted in accordance with an illustrative embodiment;

FIG. 3 is an assessment visualization displayed on a graphical user interface of dynamic data transactions depicted in accordance with an illustrative embodiment;

FIG. 4 is a graphical user interface displaying a market addition visualization depicted in accordance with an illustrative embodiment;

FIG. 5 is a graphical user interface displaying a market addition visualization depicted in accordance with an illustrative embodiment;

FIG. 6 is a graphical user interface displaying an Add Market Confirmation visualization is shown in accordance with an illustrative embodiment;

FIG. 7 is a graphical user interface displaying an Add Market Confirmation visualization is displayed in accordance with an illustrative embodiment;

FIG. 8 is a graphical user interface displaying an Assessment visualization is shown in accordance with an illustrative embodiment;

FIG. 9 is a graphical user interface displaying an Assessment visualization in a My Market Menu minimized format is shown in accordance with an illustrative embodiment;

FIG. 10 is a graphical user interface displaying an Assessment Overview visualization is shown in accordance with an illustrative embodiment;

FIG. 11A is a graphical user interface displaying a bid details visualization is shown in accordance with an illustrative embodiment;

FIG. 11B is a graphical user interface displaying an offer details visualization is shown in accordance with an illustrative embodiment;

FIG. 12 is a graphical user interface displaying a Trades Table visualization is shown in accordance with an illustrative embodiment;

FIG. 13 is a graphical user interface displaying a Trade Details visualization in a third region is shown in accordance with an illustrative embodiment;

FIG. 14 is a graphical user interface displaying a Comparison Details visualization in a fourth region is shown in accordance with an illustrative embodiment;

FIG. 15 is a block diagram of a data processing system is depicted in accordance with an illustrative embodiment; and

FIG. 16 is a flowchart of a process for controlling a display of dynamic data updates is depicted in accordance with an illustrative embodiment.

### DETAILED DESCRIPTION

The illustrative embodiments recognize and take into account one or more different considerations. For example, the illustrative embodiments recognize and take into account that a technological improvement is needed to more quickly and efficiently accessing massive amounts of data transactions in real time on computing devices than is currently available. In particular, a technological improvement is needed in processing massive data transactions in a useful format in real time is known to be challenging. Massive data transactions may be a number of data transactions that exceed 30 million per day.

The illustrative embodiments recognize and take into account that a technological improvement is needed in processing massive amounts of data transactions in real time to direct an action based upon the massive data transactions when some of the data anticipated to direct the action may be absent. Further still, the illustrative embodiments recognize and take into account that a technological improvement is needed to visualize guardrails to guidelines that direct actions based upon the massive data transactions that highlight parts of the massive data that may be classified as unusual and/or violate the guidelines that direct actions based upon the massive data transactions.

When data is streamed, or dynamically updated, a user interface itself may be dynamically updated, shifting a view of the page and disrupting access to a particular data element. For example, the illustrative embodiments recognize and take into account that an exchange may be a central marketplace with established rules and regulations where buyers and sellers can meet to trade commodities. Many of these exchanges throughout the world utilize electronic trading in varying degrees to trade stocks, bonds, futures, options and other tradable objects. Market participants can link to the electronic trading system using a trading client in communication with an electronic exchange. A trading client, typically installed on a remote computer associated with a transaction device, allows traders to participate in the market. The electronic exchange sends information about a market, such as prices and quantities, to the trading client. Using the trading client, a market participant can submit orders to the electronic exchange. The electronic exchange then attempts to consummate a trade by matching the orders submitted by the various market participants.

Transaction data 236 may be considered as a representation of an event and/or a request for an event. Hence, without limitation transaction data 236 may represent at least: orders, including bids and offers, and/or executed trades from a market. The exchange typically provides an ongoing or periodic transmission of transaction data 236 to all market participants. For example, with each submitted order, traders must supply information like the name of the commodity, quantity, restrictions, price and multiple other variables. Without this information, the market will not accept the order.

Quote streaming services are increasingly offered as an add-on with many trading clients. Real-time quotes let market participants know the exact price for a stock they are trading at a moment-to-moment rate. Participants desire to have a better idea of the price they will pay when having their order filled. Typically, quote streaming services provide market information in a ticker tape format, where published orders are recorded sequentially in a spreadsheet.

Thus, the illustrative embodiments recognize and take into account that it would be desirable to have a process and/or machine such as without limitation a computer system, and computer program product that takes into account the issues discussed above as well as other possible issues. For example, it would be desirable to have a process, apparatus, computer system, and computer program product that provides for increased comprehension and speed at which information, such as dynamic data, can be accessed and comprehended on a display as compared with using current systems.

In one illustrative example, a computer system is provided for controlling a display of dynamic data updates comprising a number of storage devices configured to store program instructions, and a number of processors operably connected to the storage devices. The number of processors are configured to execute the program instructions to cause the system to: determine at least variance and conversion among massive amounts of transactions represented by received data, wherein the viewport displays a of dynamic data within a graphical user interface; responsive to determining that, retrieve a set of data updates from a buffer; and update the sequence of dynamic data displayed in the viewport with the set of data updates, wherein the viewport is updated in real time with assessments and visualizations of summaries for normalized values for data within the transactions over selected time periods.

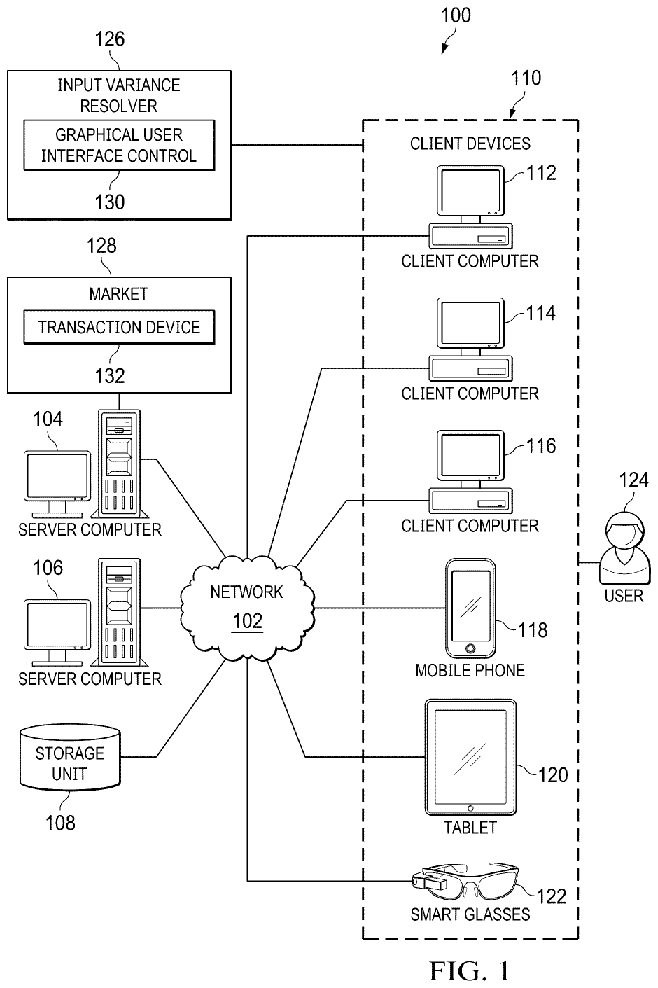

With reference now to the figures and, in particular, with reference to FIG. 1, a pictorial representation of a network of data processing systems is depicted in which illustrative embodiments may be implemented. Network data processing system 100 may be a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 may include client computer 112, client computer 114, and client computer 116. Client devices 110 can be, for example, computers, workstations, or network computers. In the depicted example, server computer 104 provides information, such as boot files, operating system images, and applications to client devices 110. Further, client devices 110 also may include other types of client devices such as mobile phone 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of: wired, optical fiber, or wireless connections.

Program code located in network data processing system 100 can be stored on a computer-recordable storage medium and downloaded to a data processing system or other device for use. For example, program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet may be a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

In this illustrative example, user 124 can interact with input variance resolver 126 running on one or more of client devices 110 to access transaction device 128. Transaction device 128 may be associated with and/or dedicated to a particular market for a particular type of transaction. Without limitation a particular market may include a market for petroleum related products.

Input variance resolver 126 may be an application for dynamically displaying resolution of variances in massive amounts of data received from a number of electronic data centers, such as transaction device 128. Without limitation, variances may include at least: a difference between a bid and an offer for a transaction, an absent data transaction value where and/or when a data transaction value may be expected, and/or a data transaction value that may be considered unusual and/or outside of an established guideline.

The illustrative embodiments recognize and take into account that a Transaction device 128 may be a physical or virtual location that processes massive amounts of data transactions per minute. Massive amounts may be at least 30 million or greater. Transaction device 128 may be an electronic market server. Transaction device 128 may be a processor as further described below.

Input variance resolver 126 may include or be in communication with graphical user interface (GUI) 130. Input variance resolver 126 may be a processor at least without limitation as further described below. Input variance resolver 126 can be implemented in software, hardware, firmware or a combination thereof. Without limitation input variance resolver 126 may represent specially programmed code within a processor at least without limitation as further described below.

Input variance resolver 126 may identify a selected transaction from a list of subscribed transaction devices 212 associated with cells displayed in first region of graphical user interface 130. Input variance resolver 126 may identify an activity session for each of the subscribed transaction devices 212. Without limitation a transaction device may be associated with and serve a particular market for a particular product. An activity session may be a period of time during which transactions (inputs and/or outputs) at transaction device 128 may be considered valid.

Input variance resolver 126 may dynamically display data transactions in the first region of graphical user interface 130. The transactions may be for identified participants associated with a particular transaction device, such as without limitation transaction device 128, during the activity session. Transactions received by input variance resolver 126 from a particular client device among client devices 110 may be displayed in a first region of graphical user interface 130 separately from the transactions submitted by some other client device among client devices 110. Without limitation graphical user interface 130 may separately display the transactions received through network 102 as a distinct column of data transactions as a function of time within the activity session.

Input variance resolver 126 may display, in a second region of graphical user interface 130, a number of transaction details that are relevant to a selected transaction received from a selected transaction device. Graphical user interface 130 may command, responsive to designation of a data transaction from a selected transaction device, an expanded portion of transaction data 236 236 to be displayed in a second region of graphical user interface 130.

As configured, embodiments described herein solve problems of prior graphical user interface devices (GUIs) and data processor interface therewith, in the context of improving speed, accuracy, and usability in processing massive numbers of data transactions and presenting them in a visual display. Rather than reciting a mathematical algorithm, a fundamental economic or longstanding commercial practice, or a challenge in business, the embodiments described herein are directed to improvements in existing processor and graphical user interface devices that have no pre-electronic trading analog. The described embodiments solve problems of prior processors and graphical user interface devices in the context of computerized data transactions relating to usability and visibility of massive data transactions.

Embodiments described herein provide significantly more than prior graphical user interface devices that merely allow for setting, displaying, and selecting data or information that is visible on a graphical user interface device. Instead, the embodiments described herein require a specific, structured graphical user interface paired with a prescribed functionality directly related to the graphical user interface's structure that is addressed to and resolves a specifically identified problem of recognizing real-time trends in processing massive numbers of transactions, and directed actions based thereupon.

Furthermore, the specific structure and concordant functionality of the graphical user interface distinguishes this system as compared to conventional computer implementations of known procedures. The proposed new application or computer-implemented function is not simply the generalized use of a computer as a tool to conduct a known or obvious process. Rather than the routine or conventional use of computers or the Internet, the embodiments described herein provide an inventive concept that allows devices and users thereof to more efficiently and accurately present and visualize real-time trends in data transactions as well as direct actions using this electronic data transaction system. When considered as a whole, the embodiments described herein overcome a problem that is necessarily rooted in computer technology and that specifically arises in the realm of computer networks, resulting in an improvement to system capabilities to include without limitation processing of massive data amounts and visualizations thereof on a display device.

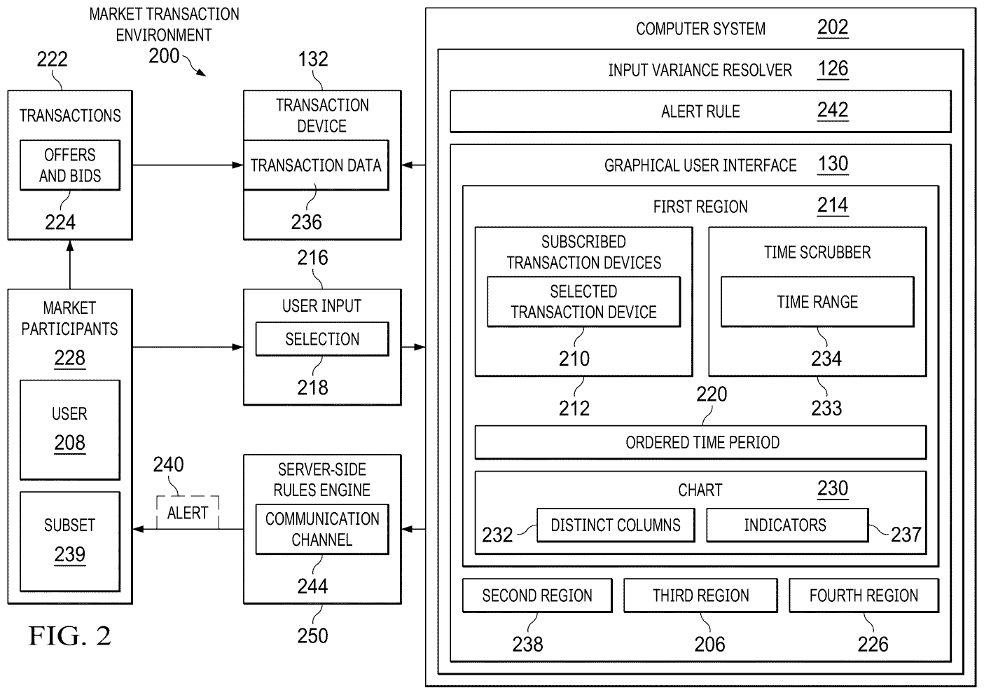

With reference now to FIG. 2, a block diagram of a data transaction environment is depicted in accordance with an illustrative embodiment. In this illustrative example, data transaction environment 200 includes components that can be implemented in hardware such as the hardware shown in network data processing system 100 in FIG. 1.

Data transaction environment 200 is an environment in which input variance resolver 126 may provide services for digitally displaying data for transactions and reports for different subscribed transactions devices over a selected period of time. Without limitation transaction device 132 may be associated with and/or execute data transactions for a particular market, such as without limitation a particular petroleum product market. As depicted, data transaction environment 200 includes input variance resolver 126. Input variance resolver 126 may be an embodiment of input variance resolver 126 shown and described in FIG. 1.

In data transaction environment 200, a process for displaying transaction values on a graphical user interface may be performed using graphical user interface (GUI) 130. GUI 130 may be considered as an embodiment of graphical user interface (GUI) 130 shown and described above for FIG. 1. In this illustrative example, a process is shown for displaying transaction values on GUI 130. GUI 130 may display data from transactions in real-time or in near real-time. In other words, data may be refreshed at least every 10 seconds. In contrast to the scrolling lines of text displayed in prior interfaces, GUI 130 allows user to visualize bids, offers, and trades transactions into an immediate, easy to understand chart displaying a resolved input variance-price convergence within a time period selected for the display. GUI 130 may also represent a strip for a data transaction, from among millions of data transactions, on the time period selected for the display.

GUI 130 may solve problems relating to speed, accuracy and usability, and visualization of prior graphical user interface devices (GUIs), in the context of computerized processing of massive data transactions. Rather than reciting a mathematical algorithm, a fundamental economic or longstanding commercial practice, or a challenge in business, GUI 130 is directed to improvements in processing of processing of massive data transactions and/or existing graphical user interface devices that have no pre-electronic trading analog. GUI 130 may utilize a structured graphical user interface paired with a prescribed functionality directly related to the graphical user interface's structure that is addressed to and resolves a specifically identified problem in the prior state of the art. In this manner, GUI 130 may provide more than setting, displaying, and selecting data or visible information in a manner of prior data visualization, amounting to significantly more than prior graphical user interface devices.

Furthermore, the specific structure and concordant functionality of GUI 130 distinguishes input variance resolver 126 as compared to conventional computer implementations of known procedures. GUI 130 is not simply the generalized use of a computer as a tool to conduct a known or obvious process. In contrast to the routine or conventional use of computers or the Internet, GUI 130 provide an inventive concept that allows transaction devices and users thereof to visualize data transaction trends more quickly, as well as efficiently and accurately direct actions using this electronic data transaction system. Therefore, GUI 130 overcomes a problem specifically arising in the realm of computer networks and necessarily rooted in computer technology, resulting in an improvement to system capabilities.

Input variance resolver 126 can be implemented in software, hardware, firmware or a combination thereof. When software is used, the operations performed by input variance resolver 126 can be implemented in program code configured to run on hardware, such as a processor unit. When firmware is used, the operations performed by input variance resolver 126 can be implemented in program code and data and stored in persistent memory to run on a processor unit. When hardware is employed, the hardware may include circuits that operate to perform the operations in input variance resolver 126.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

One or more components of input variance resolver 126 can be implemented in computer system 202. Computer system 202 may include one or more data processing systems. When more than one data processing system is present in computer system 202, those data processing systems are in communication with each other using a communications medium. The communications medium can be a network. The data processing systems can be selected from at least one of a computer, a server computer, a tablet computer, or some other suitable data processing system. When a number of processors execute instructions for a process, the number of processors can be on the same computer or on different computers in computer system 202. In other words, the process can be distributed between processors on the same or different computers in computer system 202.

As depicted, user 208 can interact with GUI 130 of input variance resolver 126 to graphically display data from transactions 222 and subscribe to various reports of data from transactions from for different transaction devices in various electronic markets. Graphical user interface (GUI) 130 may display data from transactions 222 in a manner that enables user 208 to visualize trends within transaction data 236 of transactions 222 more easily.

In one illustrative example, input variance resolver 126 may identify selected transaction device 210 from a list of subscribed transaction devices 212 displayed in first region 214 of graphical user interface (GUI) 130. Additionally, input variance resolver 126 may identify selected time period 220 for selected transaction device 210.

Input variance resolver 126 can identify selected transaction device 210 and selected time period 220 in a number of different ways. Without limitation input variance resolver 126 can identify selected transaction device 210 and selected time period 220 by receiving user input 216 from GUI 130 that may receive an input from a user 208 that may include a designation of selection 218 of one or more of selected transaction device 210 and/or selected time period 220. For example, g graphical user interface (GUI) 130 can display subscribed transaction devices 212 as graphical control element within GUI 130, such as a drop-down menu. In this example, selection 218 may identify selected transaction device 210 from subscribed transaction devices 212. Input variance resolver 126 may identify selected transaction device 210 on GUI 130 as a label of a particular market. Without limitation, input variance resolver 126 may be specially configured to transform selected transaction device 210 to present on GUI 103 as a label of a particular market. Without limitation, input variance resolver 126 may be specially configured to transform selected time period 220 to present on GUI 130 as a label of a particular date.

Input variance resolver 126 dynamically may display transactions 222 in first region 214 of graphical user interface (GUI) 130. Transactions 222 make up the transaction data 236. Transactions 222, may include without limitation offers and bids 224. Transaction device 130 typically provides this transaction data 236 to all market participants 228. For example, with each of transactions 222 submitted to transaction device 130, market participants 228 input information like the name of a commodity, quantity, restrictions, price and multiple other variables into transaction device 130. Without this information, transaction device 130 may not accept the transaction. Input variance resolver 126 may then receive information from transaction device 130.

Market participants 228 may be, without limitation, buyers and sellers of physical commodities and financial instruments tied to the value of those commodities. Market participants 228 may generate data transactions through transaction device 130. Without limitation transaction device 130 may service buyers and sellers of physical commodities and financial instruments tied to the value of those commodities. Without limitation market participants 228 may be major international and national companies, independent trading houses, and/or financial institutions, as well as end-users of the physical commodities, or entities acting on their behalf.

GUI 130 may display transactions 222 for market participants 228 in selected transaction device 210 over selected time period 220. Throughout the day, input variance resolver 126 is in constant contact with market participants 228. As soon as transactions 222 are received, input variance resolver 126 publishes the transaction data 236 to all market participants, facilitating price discovery by making all market participants 228 visible to one another and all transactions 222 transparent. In one illustrative example, transactions 222 are time-stamped, and can be displayed in chart 230 as a function of time.

Market participants 228 may offer to sell tradable objects at a given price (the ask price) and/or bid to purchase securities at a given price (the bid price). A bid-ask spread is the amount by which the ask price exceeds the bid price for the tradable object- essentially a variance between the highest price that a buyer may be willing to pay for the tradable object and the lowest price that a seller may be willing to accept. When a trade is consummated, market participants 228 may accept one of these two prices, depending on whether they wish to buy (ask price) or sell (bid price).

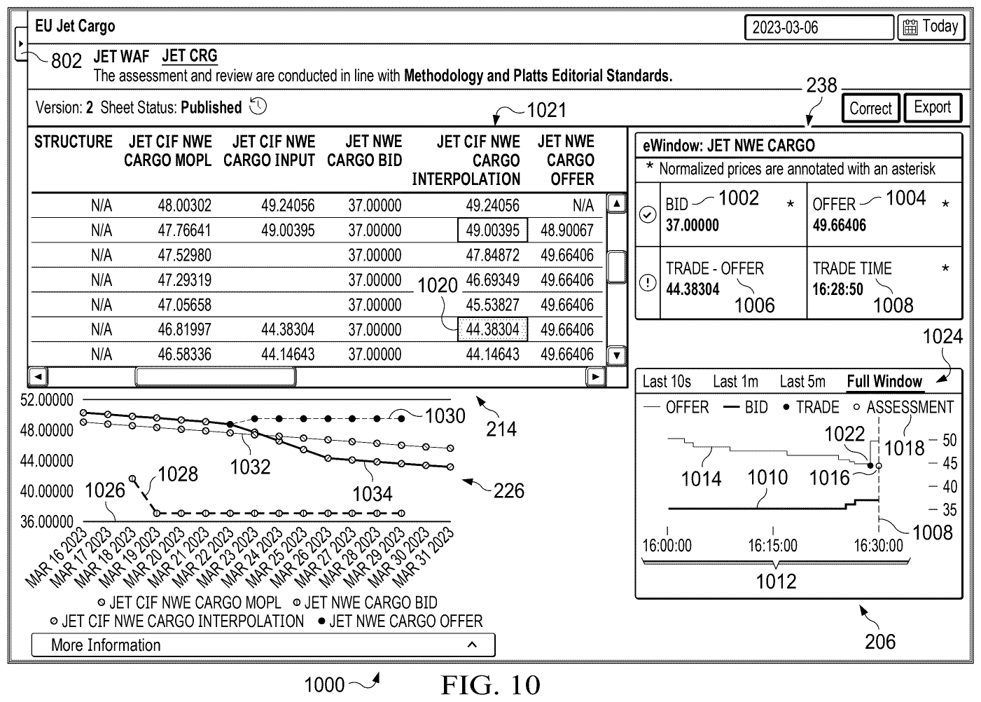

As the delivery date of an underlying cash commodity approaches, a price of a futures contract may converge toward a spot price of the commodity, such that the price of the futures and the price of the underlying commodity are nearly equal on the last day for delivery to fulfill the terms of the contract. When input variance resolver 126 receives an inquiry through chart 230 for a specified transaction data 236 element then chart 230 may transform to also present second region 238 with expanded constraints for the specified data transaction traded over selected time period 220 (as shown at least in FIGS. 10-13). Hence, chart 230 may visually represent a price convergence of a variance in offers and bids 224 for a past and an active market session.

Chart 230 may display transactions 222 received through transaction device 130 by a first one of market participants 228 separately displayed from transactions 222 submitted by other market participants 228. Transactions 222 submitted by each of market participants are separately displayed as distinct columns 232 of best offers and bids 224 by the first market participant as a function of time within selected time period 220. Each column generated may represent a best bid/offer published by a corresponding market participant in market participants 228.

At least because GUI 130 separately may display transactions 222 submitted by each of market participants 228, user 208 can quickly visualize price-trends processed through transaction device 130. At least because GUI 130 separately may display transactions 222 submitted by each of market participants 228, user 208 can quickly visualize how transactions 222 by the different ones of market participants 228 in selected transaction device 210 may affect the value of other related markets.

The process employed by input variance resolver 126 may operate on a principle that price may be a function of time. Bids, offers, and transactions are submitted by participants to input variance resolver 126 and may be published in real time throughout the day until a market closes. Providing a well-defined timestamp is significant to understanding relationships between the related markets. Input variance resolver 126 considers a timestamp of record of a market participant's intent to buy/sell at the time that input variance resolver 126 receives the information, as opposed to the time a message was sent between the market participants. By ensuring that all assessments across different markets reflect market value at the same moment in time, variances that exist between commodities are also able to be fully and properly visualized.

User 208 can alternate among multiple subscribed transaction devices 212 to see different transaction data 236 and its visual rendition within chart 230. Comparing the value of related markets is possible when the values of the different markets have been determined at the same moment in time. Comparing the value of related markets is possible when the values of the different markets have been visualized at the same moment in time.

For example, comparing the value of a raw material to a processed commodity is possible when both values have been determined at the same moment in time. By contrast, comparing the price of raw material in the morning, to processed material in the afternoon, might deeply impair the relationship between the commodities-particularly when the respective market prices move independently during the intervening period. By providing clear timestamps for assessments, input variance resolver 126 is designed to provide assessments that properly reflect an outright and a spread value during times of high volatility equally well as in times of modest volatility.

In one illustrative example, GUI 130 may display time scrubber 233 for selected time period 220 in first region 214 of the GUI 130. Time scrubber 233 may display a specific time range 234 for selected time period 220. Time scrubber 233 enables user 208 to select a specific time range 234 displayed. In response to the selection, first region 214 of GUI 130 is updated to display subset 239 of market participants 228 that are active within the transaction device 130 during the specific time range 234.

In one illustrative example, GUI 130 enables user 208 to visualize transactions 222 submitted by an individual one of market participants 228 by selecting one of distinct columns 232 displayed in chart 230. In this illustrative example, input variance resolver 126 receives selection 218 of a first one of distinct columns 232 of transactions 222 for the first one of market participants 228, selected from first region 214 of GUI 130. In response to the selection, input variance resolver 126 dynamically obscures the other ones of market participants 228 from first region 214.

In one illustrative example, GUI 130 may display indicators 237 for different transactions. For example, GUI 130 may display a first indicator associated with one of distinct columns 232, indicating that the corresponding one of market participants 228 has consummated a trade. When a bid or offer line ends at a given timestamp, GUI 130 may display a second indicator that indicates that the particular bid or offer order has been withdrawn or traded at the given timestamp.

In one illustrative example, GUI 130 may display a variance between selected ones of distinct columns 232, rather than a best offers and bids from market participants 228 collectively. For example, when input variance resolver 126 receives a selection of a first one of distinct columns 232 and a selection of a second one of distinct columns 232, input variance resolver 126 can dynamically determine a spread between the selected lines at a selected time within the selected time period 220.

In one illustrative example, input variance resolver 126 enables user 208 to submit transactions 222 to transaction device 130 based on the spread between different ones of distinct columns 232. For example, user 208 can enter user input 216 within first region 214 of GUI 130 instructing input variance resolver 126 to submit transactions 222 to transaction device 130 based on the spread between the selected ones of distinct columns 232.

In one illustrative example, input variance resolver 126 may present alerts 240 based on transaction data 236 236. Alerts may be triggered by alert rule 242. Input variance resolver 126 may thereafter register alert rule 242, for example, with a server-side rules engine 250, so that alert 240 is communicated to user 208 over selected channel 246 and independent from input variance resolver 126 and/or via a transformation of display visualized in first region 214 on GUI 130.

In one illustrative example, one or more technical solutions are present that overcome a technical problem with the display of bids, offers and trades transactions in known graphical user interfaces. As a result, one or more technical solutions may provide a technical effect in the context of computerized trading, relating to speed, accuracy, and usability. GUI 130 may display transaction data 236 236 in real-time or near real-time. In contrast to the scrolling lines of text displayed in prior interfaces, GUI 130 allows user to visualize bids, offers, and trades transactions into an immediate, easy-to-understand chart showing the price convergence within the time period selected for the display.

Computer system can be configured to perform at least one of the steps, operations, or actions described in the different illustrative examples using software, hardware, firmware or a combination thereof. As a result, computer system operates as a special purpose computer system in which GUI 130 in computer system enables a user to visualize of bids, offers, and trades transactions into an immediate, easy to understand chart 230 showing the price convergence within the selected time period 220. In particular, GUI 130 transforms computer system into a special purpose computer system as compared to currently available general computer systems that do not have GUI 130.

In the illustrative example, the use of GUI 130 in computer system integrates processes into a practical application for displaying market transactions that increases the performance of computer system 202. Rather than reciting a mathematical algorithm, a fundamental economic or longstanding commercial practice, or a challenge in business, the embodiments described herein are directed to improvements in existing graphical user interface devices that have no pre-electronic trading analog. GUI 130 solves problems of prior graphical user interface devices in the context of computerized trading relating to usability and visibility. GUI 130 provides significantly more than prior graphical user interface devices that merely allow for setting, displaying, and selecting data or information that is visible on a graphical user interface device. Instead, GUI 130 utilizes a specific, structured graphical user interface paired with a prescribed functionality directly related to the structure of the interface that is addressed to and resolves a specifically identified problem of recognizing real-time trends in market orders.

Furthermore, the specific structure and concordant functionality of GUI 130 distinguishes this system as compared to conventional computer implementations of known procedures. The proposed new application or computer-implemented function is not simply the generalized use of a computer as a tool to conduct a known or obvious process. Rather than the routine or conventional use of computers or the Internet, GUI 130 provides an inventive concept that allows traders to visualize real-time trends more efficiently and accurately in market transactions, as well as initiating transactions and subscribing to market reports using input variance resolver 126. Therefore, when considered as a whole, GUI 130 overcomes a problem that is necessarily rooted in computer technology and specifically arising in the realm of computer networks, resulting in an improvement to system capabilities.

The illustration of input variance resolver 126 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

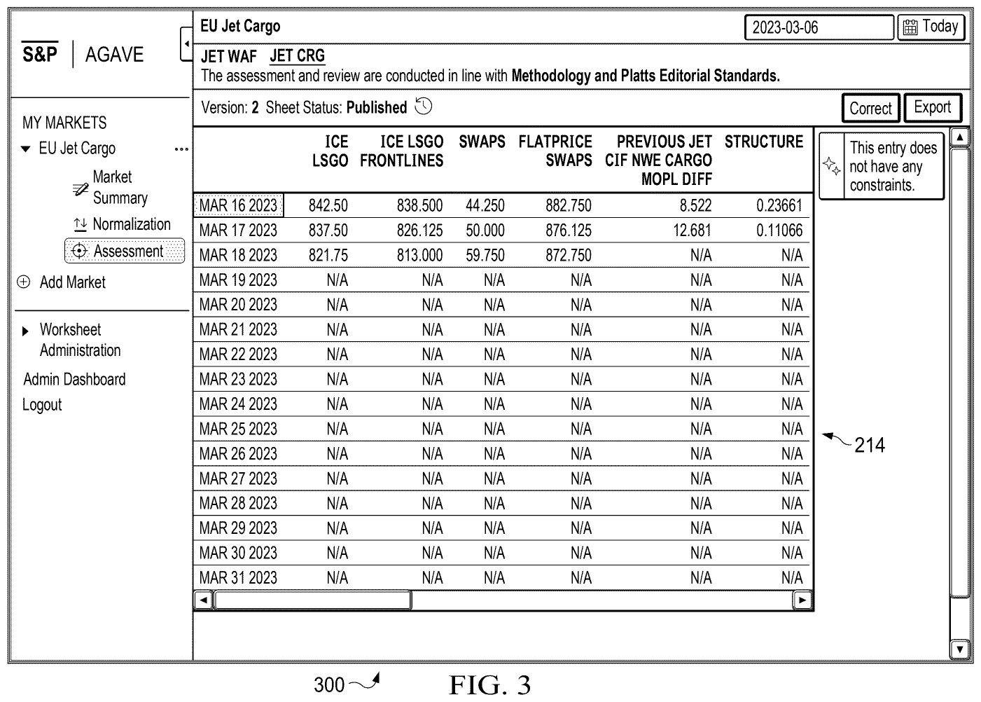

With reference to FIG. 3, an assessment visualization displayed on a graphical user interface of dynamic data transactions is depicted in accordance with an illustrative embodiment. As depicted, assessment visualization 300 may be an example of one implementation for a visualization that may be displayed by GUI 130 of FIG. 2 that may be representative of GUI 130 in FIG. 1. As depicted, graphical user interface may include at least: first region 214, second region 238, third region 206, and/or fourth region 226.

Input variance resolver 126 (representative of Input variance resolver 126) may be configured to visualize a number of distinct columns 232 into a display of chart 230 on GUI 130 in first region 214. Input variance resolver 126 may be configured to visualize a column for each transaction device 130 that input variance resolver 126 receives transaction data 236 236 from. Each transaction device 130 may be labeled with a name of a market that provides the transaction data 236 to the transaction device 130 used by and/or associated with the market.

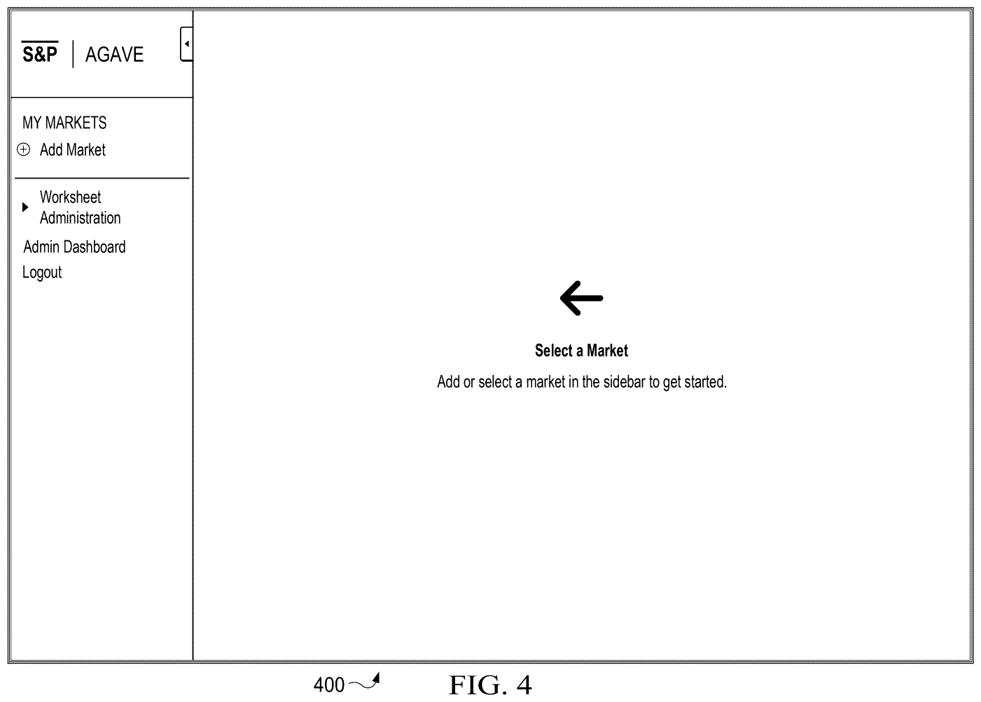

Designation of transaction device 130 that input variance resolver 126 will accept data transactions from and/or visualize in a column in first region 214 labeled with a market name may be initialized in through a series of market addition visualizations displayed on GUI 130 and designations received thereon by a process described below in more detail with FIGS. 4-ss.

With reference to FIG. 4, a graphical user interface displaying a market addition visualization is depicted in accordance with an illustrative embodiment. As depicted, market addition visualization 400 on GUI 130 is shown before receiving initialization input that allows input variance resolver 126 to accept data transactions from a particular transaction device 130 associated with a particular market and become one of subscribed transaction devices 212. When GUI 126 receives input activating Add Market key 402 on market addition visualization 400 on GUI 130, input variance resolver 126 initializes authorization to receive data transactions from transaction device 130. Input activating Add Market key 402 on market addition visualization 400 on GUI 130 may be without limitation a mouse click, a designated key stroke, a verbal command, or any other appropriate input to GUI 130 that designates selection and activation of process that initializes an authorization and activation of reception of transaction data 236 236 from a selected transaction device 210 by input variance resolver 126.

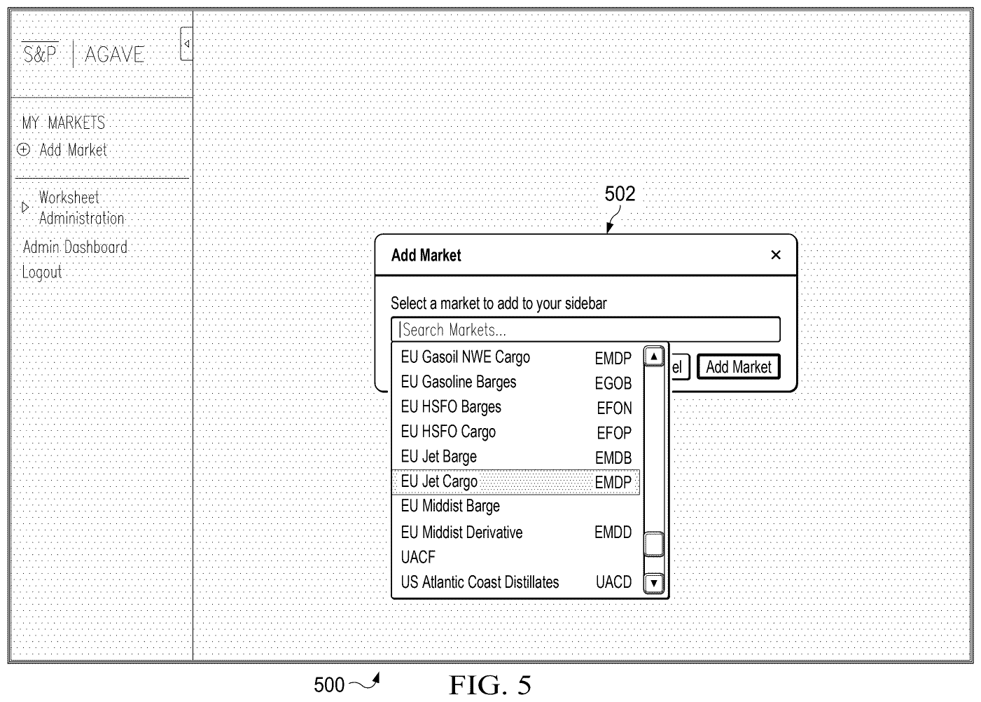

Now turning to FIG. 5, FIG. 5 shows a graphical user interface displaying a market addition visualization depicted in accordance with an illustrative embodiment. As depicted, second market addition visualization 500 on GUI 130 is shown after receiving initialization input that allows input variance resolver 126 to accept data transactions from a particular transaction device 130 associated with a particular market to become one of subscribed transaction devices 212.

With reference to FIG. 5, a graphical user interface displaying an Add Market Selection Menu is shown in accordance with an illustrative embodiment. As depicted, Add Market Selection Menu 502 is presented on GUI 130 responsive prior activation of Add Market Key 402. Add Market Selection Menu 502 may display a window configured with a variety of Markets that may possess a transaction device 130 that may be selected to allow input variance resolver 126 to accept data transactions from that particular transaction device 130 associated with that market to become one of subscribed transaction devices 212. Without limitation Market Selection Menu 502 may be presented as a scroll with a scrollable bar 504 configured to allow scrolling to view all possible choices of markets.

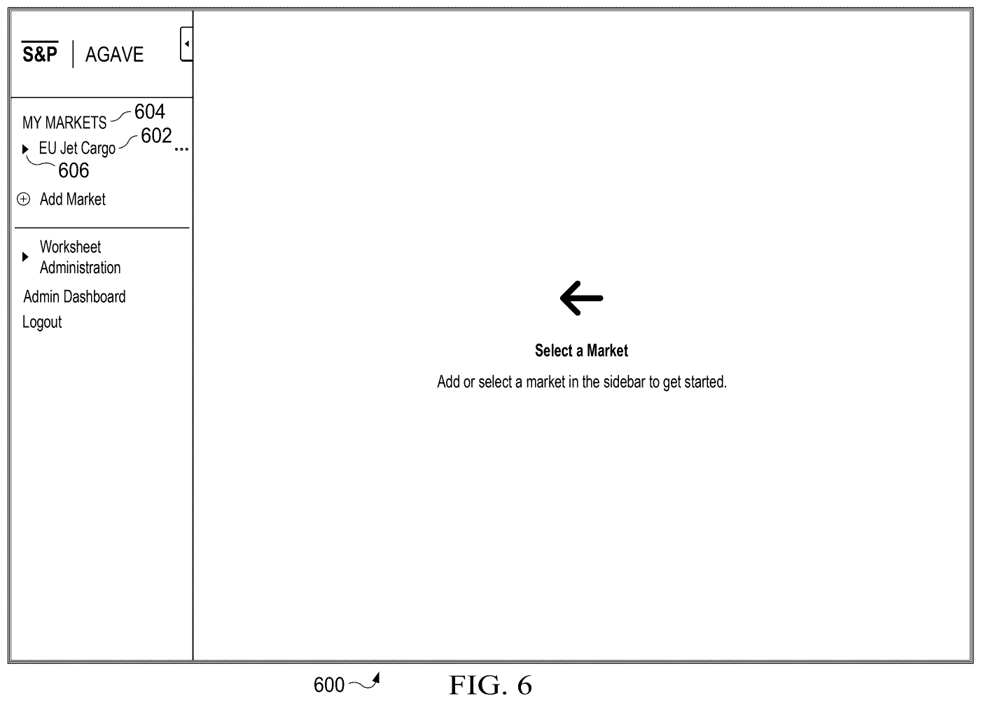

With reference to FIG. 6, a graphical user interface displaying an Add Market Confirmation visualization is shown in accordance with an illustrative embodiment. Specifically, Add Market Confirmation 600 is displayed following when input variance resolver 126 receives a selection of a market listed in Market Selection Menu 502. Title 602 indicates confirmation that selection of a market listed in Market Selection Menu 502 has been received, authorized, and added by input variance resolver 126 into My Markets Menu 604 as shown in FIG. 6.

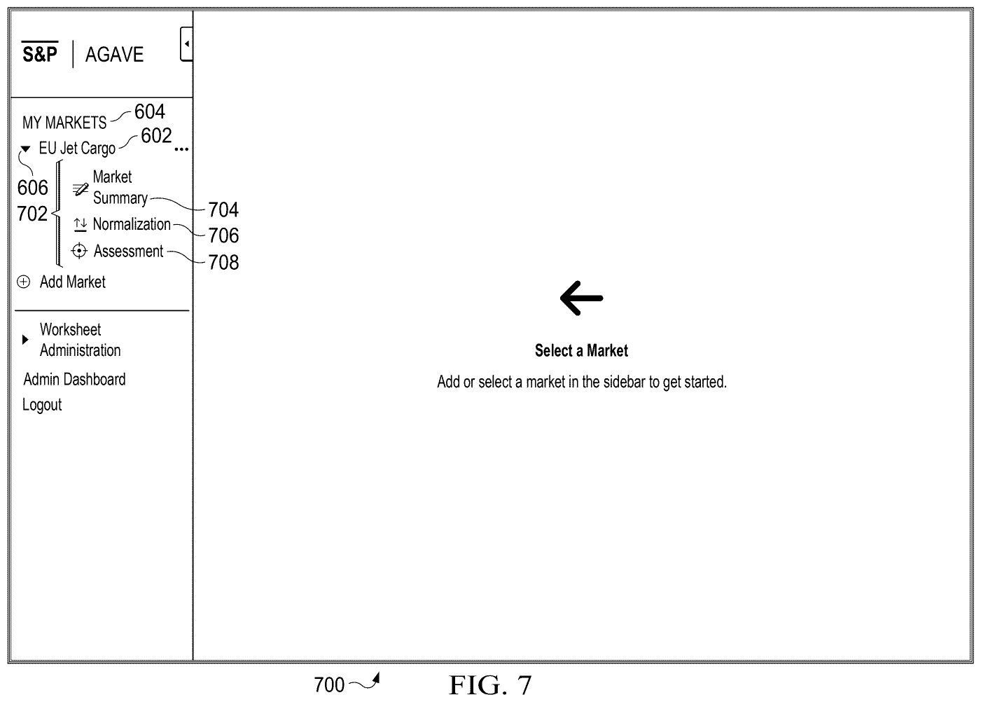

With reference to FIG. 7, a graphical user interface displaying an Add Market Confirmation visualization is displayed in accordance with an illustrative embodiment. Specifically, My Market Expansion 700 visualization is displayed following when GUI 130 receives a selection for expansion of a selected market in My Markets Menu 604. Title 602 indicates expansion of a market listed in My Markets Menu 604 has been activated, to reveal option to select from visualizations menu 702 for market selected in My Markets Menu 604 as shown in FIG. 7. Without limitation, selection of expansion may be activated by activation on symbol 606 shown in FIG. 6. Market Summary 704, Normalization 706, or Assessment 708 visualizations may be presented for selection.

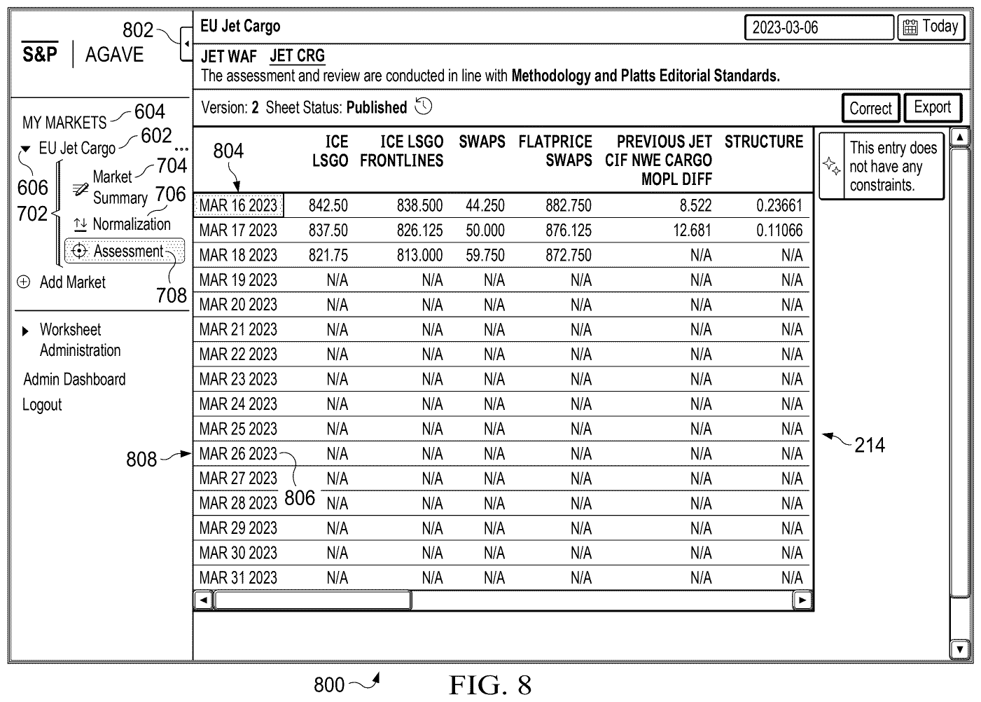

With reference to FIG. 8, a graphical user interface displaying an Assessment visualization is shown in accordance with an illustrative embodiment. Specifically, Assessment visualization 800 is displayed following when GUI 130 receives a selection of Assessment 708 in My Market Expansion 700 visualization. Assessment visualization 800 may present at least My Markets Menu 604, first region 214, and minimization tab 802. Minimization tab 802 may be selected to reformat Assessment visualization 800 by hiding My Markets Menu 604 and expanding first region 214.

First Region 214 presents visualizations of transaction data 236 236 received from a transaction device, such as without limitation transaction device 132 with YYYYYYY. First Region 214 may present column 804 that may present a time assigned 806 for a specific set of transaction data 236 received in transaction data 236 236. Row 808 in first region 214 may present a collection of categories for transaction data 236 236.

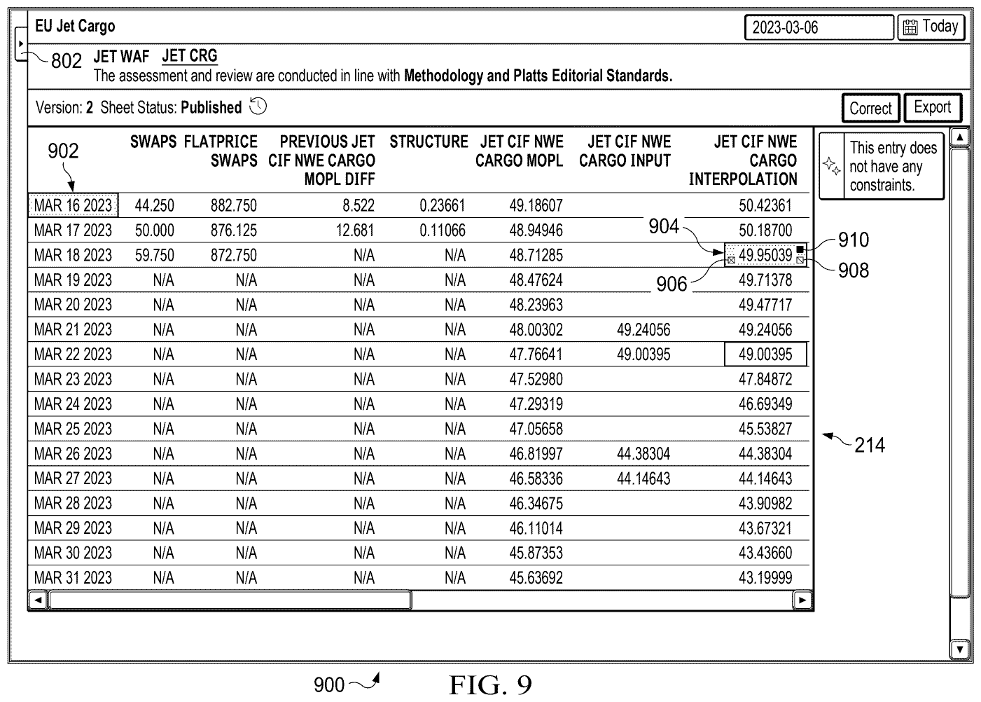

With reference to FIG. 9, a graphical user interface displaying an Assessment visualization in a My Market Menu minimized format is shown in accordance with an illustrative embodiment. Specifically, Assessment visualization 800 is transformed for display as My Market Menu minimized 900 format visualization following when GUI 130 receives an activation of minimization tab 802 in Assessment visualization 800. My Market Menu minimized 900 visualization may present first region 214 transformed into an expanded version. Without limitation, first region 214 may be expanded to increase size and/or perception for a user, such as without limitation user 124, of transaction data 236 236 presented within first region 214. Reformatting first region 214 display of at least transaction data 236 236 in Minimized My Market Menu minimized 900 visualization may at least improve resolution and readability of transaction data 236 236 presented within first region 214 to include at least column 804 that may present a time assigned 806 for a specific set of transaction data 236 in transaction data 236 236 received and in row 808.

Chart shown in first region 214 of FIG. 9 may be representative of chart 230 presented in FIG. 2 and described herein. Within any cell, such as without limitation cell 904, indicator 906 may be present to indicate that transaction data 236 represented by cell 904 include a transaction that includes a bid for a product. Indicator 906 may have a color code as well. Without limitation, color code for indicator 906 may be red. Indicator 906 may have a location within cell 904 as well. Without limitation, location for indicator 906 within cell may be a lower left corner. Indicator 906 may have a shape within cell 904 as well. Without limitation, shape for indicator 906 within cell may be a square.

Within any cell, such as without limitation cell 904, indicator 908 may be present to indicate that transaction data 236 represented by cell 904 include a transaction that includes an offer for a product. Indicator 908 may have a color code as well. Without limitation, color code for indicator 908 may be green. Indicator 908 may have a location within cell 904 as well. Without limitation, location for indicator 908 within cell may be a lower right corner. Indicator 908 may have a shape within cell 904 as well. Without limitation, shape for indicator 908 within cell may be a square.

Within any cell, such as without limitation cell 904, indicator 910 may be present to indicate that transaction data 236 represented by cell 904 include a transaction that includes a trade of a product. Indicator 910 may have a color code as well. Without limitation, color code for indicator 910 may be black. Indicator 910 may have a location within cell 904 as well. Without limitation, location for indicator 910 within cell may be an upper right corner. Indicator 910 may have a shape within cell 904 as well. Without limitation, shape for indicator 910 within cell may be a square.

With reference to FIG. 10, a graphical user interface displaying an Assessment Overview visualization is shown in accordance with an illustrative embodiment. Specifically, Assessment Overview visualization 1000 is displayed following when GUI 130 receives an activation of a designated cell in first region 214 in Assessment visualization 800 or My Market Menu minimized 900 visualization, such as without limitation cell 1020.

Any cell of data within first region 214, such as without limitation cell 1020, may be designated to activate a presentation of at least: second region 238, third region 206, and/or fourth region 226 by input variance resolver 126. Designation of any cell in first region 214, such as without limitation cell 1020, may be indicated by shading of cell 1020. Without limitation, designation shading may be a blue color. Cell 1020 may be activated to have input variance resolver 126 reformat My Market Menu minimized 900 visualization to present at least second region 238 and third region 206 on GUI 130. The value from cell 1020 may be represented in third region 206. The value from cell 1020 may be represented by a circled dot, such as without limitation indication 2016 in third region 206. Without limitation, circled dot of indication 2016 may also be filled in with a blue color.

When cell 1020 is activated, My Market Menu minimized 900 visualization is transformed by input variance resolver 126 to present at least: second region 238, third region 206, and/or fourth region 226 along with first region 214 reformatted to accommodate presentation of second region 238, third region 206, and fourth region 226 in GUI 130. Without limitation, first region 214 may be expanded to increase size and/or perception of transaction data 236 236 presented within first region 214. Input variance resolver 126 may receive without limitation at least 30 million transactions per day from respective transaction device 132 for each market 128 represented by a column in first region 214.

In other words, if the user selects a cell, such as without limitation cell 1020 or cell 904 of FIG. 9, any bids, offers, trades in transaction data 236 associated with the selected cell may be reformatted and presented by input variance resolver 126 in second region 238. Second region 238 will show the most competitive (highest amongst all active bids) bid 1002 and offer 1004 (lowest amongst all active offers) and all trades 1006 that occurred till that time. Input variance resolver 126 may also transform bids and offers of transaction data 236 represented by a selected cell in chart 230 of first region 214 in chart format in third region 206 (input variance resolver 126 is filtering the most competitive bid/offer for every new order price or update in the transaction data 236 during the market on close window (last 30 mins before a market associated with transaction device 132 closes) and trades as “dots” with a timestamp presented on at least bid trend 1010 or offer trend 1014. Input variance resolver 126 is also configured to filter the and present at least bid trend 1010 or offer trend 1014 over time range 1012 designated for the last 10 seconds, 1 min, 5 min or full 30 mins as indicated by selection window 1024 in reference to a closing time for a market associated with a transaction device 132 delivering transaction data 236 to input variance resolver 126.

Filtering logic 134 may weigh data transaction inputs for at least quantity, price, timing, and/or type of market order, for each transaction received. Filtering logic 134 is configured with special programing configured to execute at least the steps of: retrieving data that represents all contracts and spreads for a specific time period/date; require at least 500 records to provide an editor in input variance resolver 126 with enough information to assess price; based on the price, quantity and the time when they are placed, remove any duplicate orders (e.g. data transactions for an order at the same timestamp such as if there are bids with price as $2, $3, $4 and $5, only the $5 order would be forwarded through filter to inconsequential values for all lower orders in the time period/date); evaluate data transactions placed at different time period/date to identify a most significant data transaction (highest priced bids/lowest priced offers) for a particular time period/date; create a final list of the most significant data transaction (bids/offers) for each different time period/date; add a color to a cell based on the value entered in the respective cell which is compared with the best offers and bids applicable for the cell value. Each row in first region 214 may represent a distinct time period/date.

Further, filtering logic 134 in input variance resolver 126 is configured with special programming configured to detect any anomaly and/or significant variation in a value within data transactions received. Hence, filtering logic 134 in input variance resolver 126 provides the technological benefit of isolating and/or highlighting data outside of assessment guardrails, and thereby significantly reducing review time required of user 124 of data transactions received from a plurality of respective transaction device 132. The reduction of review time required of user 124 increase by magnitudes when data transactions cover a time period of such as 48 months.

Without limitation, data outside of assessment guardrails may trigger alert rule 242 that may activate input variance resolver 126 to highlight associated data being outside of assessment guardrails by shading a cell in first region 214 associated with received data transactions outside of assessment guardrails. Cell highlight may be differentiated from a cell selected (such as without limitation cell 1020) to control display of data in second region 238 by a different color shading. As a non-limiting example, selected cell 1020 may be shaded blue and any cell that triggers alert rule 242 with data outside of assessment guardrails may be shaded red.

Filtering logic 134 in structure and operation at least reduces a volume of data forwarded for further processing and hence produces the technical improvements to processing and/or visualizing transaction data 236 that reduces processing resources, energy, and time required to formulate at least assessments, normalizations, market summaries, and visualizations thereof. More specifically, filtering logic 134 and input variance resolver 126 may formulate at least assessments, normalizations, market summaries, and visualizations thereof, for data transactions received from a plurality of respective transaction device 132 in as little as one-thousandth of a second.

Input variance resolver 126 is configured with a special program configured to receive and process data transactions and to arrange and visualize them in a visually digestible way that distinguishes orders applicable for a variety of specific contracts in seconds on a single screen. In a single click on a single cell, GUI 130 may present: a best bid applicable, a best offer applicable, a list of applicable bids and offers, bids and offers plotted on a graph, in one glance—a floor for bids and a ceiling for offers that helps reviewing all the assessments with reference to their best bid and offer, guardrails for the assessed values for bids and offers in a data transaction (e.g. if a bid is received at $5 and an offer is received at $10, and an editor enters a bid of $4 or an offer of $11, input variance resolver 126 will highlight a cell representing the data transactions in a red color showing it is being assessed outside the guardrails. Hence, input variance resolver 126 provides a machine and/or process that reduces a user's effort of going through multiple documents and data consolidation represented by a single cell in first region 214 of GUI 130 that used to take around an hour in the legacy processes used without input variance resolver 126 and the visualizations it is configured to present in GUI 130.

Input variance resolver 126 is configured with a special program configured to apply filtering logic 134 to all data for data transactions received from respective transaction device 132 for each respective market 128. More specifically, input variance resolver 126 is configured with a special program configured to present Bid 1002, Offer 1004, Trade-Offer 1006, and Trade Time 1008 associated with transaction data 236 within cell 1020 in second region 238. Trade-Offer 1006, indicates that a market order which was placed as an offer has actually traded. It can either be for an outright or a spread. An outright may be for a specified timestamp, whereas a spread may be offers over a range of timestamps. A spread or an outright for a product may be displayed as a collection of cells aligned within a particular column of columns 232 described in FIG. 2 and at least as shown without limitation by column 1021 in FIG. 10.

In other words, an outright generally may represent monthly contracts e.g. Jan24, February 24, and spreads would represent a period including several months Jan24/Feb24.
In terms of e Window markets, outrights and spreads have their own dedicated columns like 1021 in FIG. 10 and they both may represent their transactional data (bids, offers, trades) in second region 238 and third region 206 based on the user selection.
In terms of Platts Forward Curves markets, transaction data 236 (bids/offers/trades) for outrights and spreads can be associated to one column such as without limitation column 1021 in FIG. 10 and display one section of second region 238 and third region 206 for outrights, and another section of second region 238 and third region 206 for spreads (not shown).

In other words, input variance resolver 126 is configured with a special program configured to apply Graphql to query data transactions received from transaction device 132 and retrieve market orders based on product root and trading time period within the data transactions. The data transactions received may be further filtered using orderbook. An activation of a cell, such as without limitation cell 1020, in first region 214 determines executed trades and spreads for data transactions associated with cell 1020 which are shown in second region 238 and the difference in between them may be auto calculated and presented as a second layer of display presented in second region 238 (not shown). The auto calculation and visibility of all orders separately for each cell provides a technological improvement of greatly reducing effort by user 124, as the data transactions may represent data for combinations of transactions for as much for 48 months into future dates. Without limitation the data transactions may be for commodities being traded on an exchange. Through a single cell, in GUI 130, input variance resolver 126 may process and represent for each contract represented by transaction data 236 236 received from transaction device 132 processed data for prices involved in each contract in transaction data 236.

Still further in second region 238, values presented may be normalized. Normalized values are indicated by the “*” symbol. A normalized value in second region 238 may be normalized by a normalizing program in input variance resolver 126 that: recognizes a pricing basis defined by a trader while placing an order into transaction data 236 that generates a swaps curve based on a swaps assessment (a swaps curve represents a price of a commodity at different points in the future, and is generally generated for the balance of a month, and next two months); recognizes that price reporters select the a basis period based on a definition provided by the trader's in the order details (a single price may be derived after averaging out the prices that fall in a time period per selected basis period); from the above, deriving a Main Price for a majority of the order's volume; calculating an Operational Tolerance (Optol) price for the remaining volume (generally defined by traders or 10% of volume) with the similar process with Optol quantity and Optol percent utilization desired defined by the price reporter; a Freight Price associated with an order can also be directly added to main and optol prices if applicable; generates a Pre-normalized price from a sum of a Main Price, and Optol Price, and a Freight Price calculated above; use the Pre-normalized price and adjust based upon multiple factors that may include: quality difference, port/location specification adjustments that can be applied by user input prices that are further added/subtracted to generate a normalization price; finally generate a normalized price for a market order in transaction data 236 derived from combining the Pre-normalized price and normalization price.

Input variance resolver 126 is configured with a special program configured to present in third region 206 a plot of Bid Trend 1010 that visualizes values for Bid 1002 over Time Range 1012 associated with Trade Time 1008 that form a bid guardrail or limit for transaction data 236 received for selected cell 1020. Input variance resolver 126 is configured with a special program configured to present in third region 206 a plot of Offer Trend 1014 that visualizes values for Offer 1004 over Time Range 1012 associated with Trade Time 1008. Input variance resolver 126 is configured with a special program configured to present in third region 206 an indication 1022 of the value of Trade-Offer 1006 at Trade Time 1008 that form an offer guardrail or limit for transaction data 236 received for selected cell 1020. Calculating an Operational Tolerance price for the remaining volume may allow a price reporter to define how much optol percentage is desired to take into calculation while normalizing a market placed order price.

Further, input variance resolver 126 is configured with a special program configured to derive and present in third region 206 indication 1016 of the value of assessment 1018. Value for assessment 1018 indicated in third region 206 may be derived by input variance resolver 126 being configured with a special program configured to assess delivery terms, specifications, and/or grade/quality associated with a commodity involved in a transaction represented in received data transactions and determine a Normalized price. As a non-limiting example, suppose a commodity involved in a transaction represented in received data transactions has a basis location of Amsterdam and a trader has floated an offer from Hamberg at $5. Input variance resolver 126 may apply a normalization that includes a freight cost of say $2 that may be based on the specifications, delivery terms, and/or grade/quality of the commodity to make that Hamberg order to basis Amsterdam.

Input variance resolver 126 is configured with a special program configured to transform presentation of third region 206 through activation of in selection window 1024 in GUI 130 of a choice from among “Last 10 s” (seconds), “Last 1 M” (minute) “Last 5 m” (minutes) or “Full Window” options in selection window 1024. Full Window may be a pre-designated period of time which may be without limitation 30 minutes. Selection of one of “Last 10 s” (seconds), “Last 1 M” (minute) “Last 5 m” (minutes) or “Full Window” (shown in FIG. 10 as selected) options in selection window 1024 activates input variance resolver 126 to transform values for Time Range 1012 presented for trade times presented in third region, and hence for all values along Bid Trend 1010 and Offer Trend 1014 as well as for indication 1022 of the value of Trade-Offer 1006 at Trade Time 1008 and indication 1016 of the value of assessment 1018. Hence, presentation generated in third region 206 may also be called a Convergence Chart. Bid Trend 1010 and Offer Trend 1014 shown in Convergence Chart/third region 206 may also be referred to as guardrails.

Input variance resolver 126 is configured with a special program configured to derive and present in fourth region 226 values for a selected market across time line 1026 forming bid line 1028, offer line 1030, Mean of Platts London (MOPL) line 1032, and Interpolation line 1034. MOPL line 1032 represents a strip of values derived from taking the value of the paper and adding on yesterday's difference between the paper and the physical assessment for a number of products represented in transaction data 236 for market participants 228. The MOPL strip is defined as the average of the forward values for the sequence of the 16 days for cargoes and either 11 or 13 days for barges that represent the future delivery or loading dates reflected in Platts middle distillates physical assessments. These strip values are calculated using Platts assessments of related derivatives for balance month, month one and month two. In other words, a MOPL strip reflects the value of a physical product in relation to the underlying forward curve aligned with the loading or delivery window reflected in the physical assessment.

Input variance resolver 126 is configured with a special program configured to derive a value for each point on time line 1026 for associated point on interpolation line 1034 as a derived value for unknown values that lie in between the known data points in transaction data 236 236 received. Each value derived by input variance resolver 126 for each point on time line 1026 for associated point on interpolation line 1034 assumes that a change between two values is linear and that a margin of error is insignificant.

Without limitation, input variance resolver 126 may utilize the following formula to performs linear interpolation to derive and assign to interpolation line 1034 a value respectively at each point on time line 1026:
step_value=(end_row_cell_value-start_row_cell_value)/(end_row_number-start_row_number)
where end_row_cell_value is the cell value of the last row, and
start_row_cell_value is the cell value of the first row.end_row_number and
start_row_number are the row numbers of last and first row respectively.
second_row_cell_value=start_row_cell_value+step_value
third_row_cell_value=second_row_cell_value+step_value

Furthermore, for every cell in first region 214, input variance resolver 126 may derive an interpolation value for data transactions received for that cell as required by any unknown values missing from the transaction data 236.

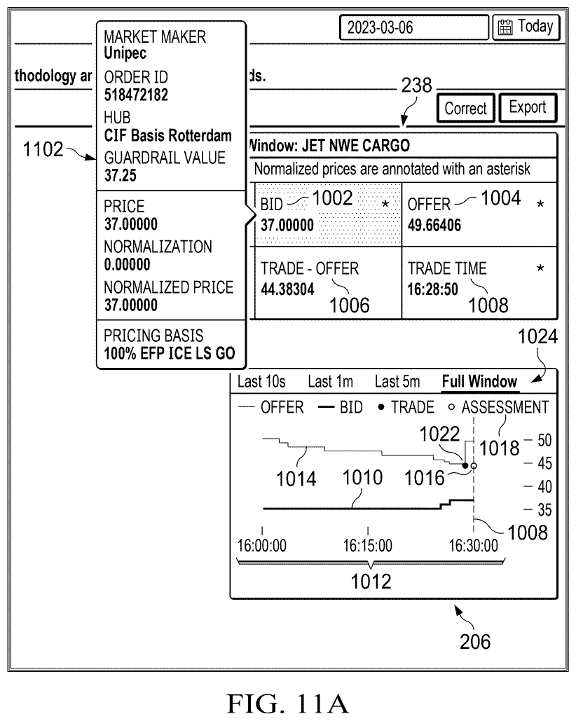

With reference to FIG. 11A, a graphical user interface displaying a bid details visualization is shown in accordance with an illustrative embodiment. Specifically, input variance resolver 126 is configured with a special program configured to present bid details 1102 over second region 238 and a portion of third region 206 responsive to an activation on GUI 130 over Bid 1002 within second region 238. Without limitation, activation on GUI 130 may include hovering a mouse pointer over BID 1002. Without limitation bid details 1102 may include: Market Maker, Order ID, HUB, Guardrail value, price, Normalization, Normalized price, and pricing basis, drawn and/or derived from among all data received associated with cell 1020. Market Maker may indicate a company or entity in market participants 228 that places a bid or an offer on an exchange transmitted to input variance resolver 126 as a part of transaction data 236. OrderId may be a unique ID allocated to each order/transaction when placed as new.

Guardrail Value is a value derived with 25 cents away from the Normalized value (e.g., when Normalized value is 37 and guardrail rule defined in backed in 0.25 the guardrail value will be 37.25. Price represents a Pre-normalization price. Normalization is a process that applies a factor that adds or subtracts from the Pre-normalization price due to: quality, grade, etc. Normalized Price is the final standardized price after addition of both pre-normalization and normalization. Pricing Basis is selected by a trader while placing an order on an exchange to define the basis of that product (e.g., Platts HSFO Med Crg has the options ‘3.5% CIF Med cargoes, 1% FOB NWE cargoes, 3.5% FOB NWE cargoes, 3.5% CIF NWE cargoes, 1% CIF Med cargoes, 1% FOB Med cargoes, 3.5% FOB Rdam barges, 3.5% FOB Med cargoes, Flat Price’).

In other words, input variance resolver 126 may not present all data by market participants or differentiate their orders. Instead, input variance resolver 126 may filter all the transaction data 236 associated within their exchange timestamp. Then, a market participant 228 information along with other metadata may be presented for transaction data 236 associated with designated cell 1020 (without limitation by a mouse hover over any particular section within second region 238. In other words, if there were two offers with $5 from Shell and $10 dollars from BP. Out of these the best offer (lowest) is $5 so special programing algorithms within input variance resolver 126 will present only the $5 order and display Shell's name on hover along with other metadata associated for that filtered market participant and timestamp associated with the transactions data 222 for designated cell 1020 in first region 214.

With reference to FIG. 11B, a graphical user interface displaying an offer details visualization is shown in accordance with an illustrative embodiment. Specifically, input variance resolver 126 is configured with a special program configured to present offer details 1104 over second region 238 and a portion of third region 206 responsive to an activation on GUI 130 over OFFER 1004 within second region 238. Without limitation, activation on GUI 130 may include hovering a mouse pointer over OFFER 1004. Without limitation offer details 1104 may include (as defined above): Market Maker, Order ID, HUB, Guardrail value, price, Normalization, and Normalized price, drawn and/or derived from among all data received associated with cell 1020. With reference to FIG. 11C [AGAVE REV SLIDE 3], a graphical user interface displaying a trade details visualization is shown in accordance with an illustrative embodiment. Specifically, input variance resolver 126 is configured with a special program configured to present trade details 1106 to a side of second region 238 and third region 206 and over a portion of first region 214 responsive to an activation on GUI 130 over TRADE-OFFER 1006 within second region 238. Without limitation, activation on GUI 130 may include hovering a mouse pointer over OFFER 1004. Without limitation offer details 1104 may include: Market Maker, Order ID, CounterParty, Hub, Price, Normalization, and Normalized price, drawn and/or derived from among all data received associated with cell 1020. A Counterparty may be one who lifts an order paced by a market participant to trade. In the case of an order-bid match, one who places an order first becomes a market maker and another who places an order after and then it gets matched with a standing order, then the second market participant will be listed as a Counterparty for this trade.

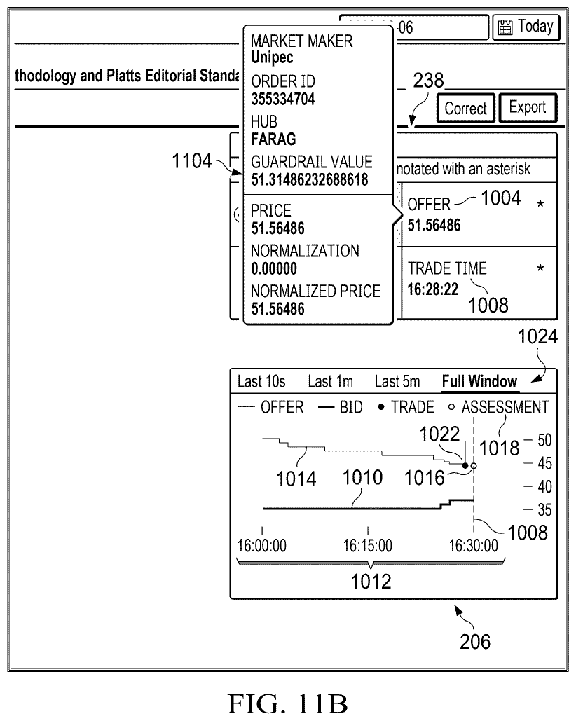

With reference to FIG. 12, a graphical user interface displaying a Trades Table visualization is shown in accordance with an illustrative embodiment. Specifically, input variance resolver 126 is configured with a special program configured to present Trades Table 1200 over (not shown) second region 238 and a portion of third region 206 responsive to an activation on GUI 130 of an e Window 1202 by grey dots that may be presented along bid trend 1010 or offer trend 1014 in third region 206. Trade-Offer 1006 at Trade Time 1008 visualization in second region 238 may be expanded as shown in

FIG. 12 to include up to six additional values for Trade-BID 1007 at additional values for Trade Time 1008 as shown in FIG. 12 by Trade-Offers 1204-1214 at Trade Times 1216-1226 associated therewith respectively.

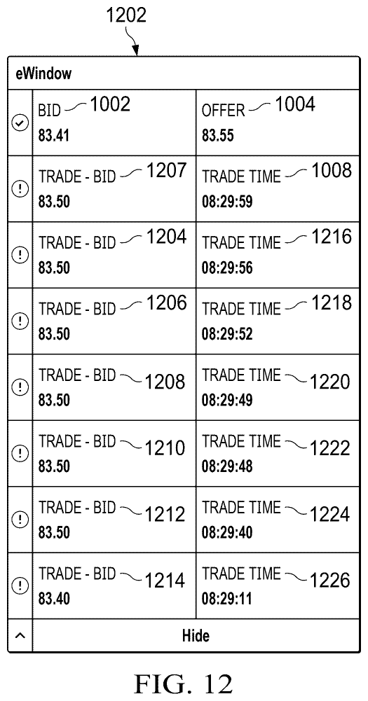

With reference to FIG. 13, a graphical user interface displaying a Trade Details visualization in a third region is shown in accordance with an illustrative embodiment. Specifically, input variance resolver 126 is configured with a special program configured to present Trade Details 1300. Trade Details 1300 are presented for Trade Time 1302 selected by time selection 1304 vertical line.

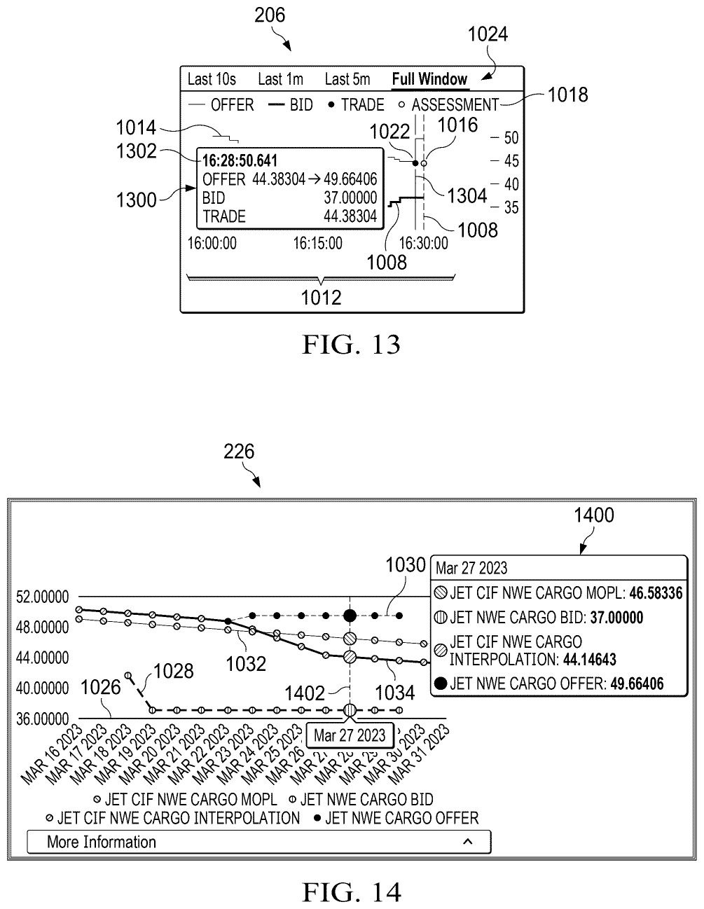

With reference to FIG. 14, a graphical user interface displaying a Comparison Details visualization in a fourth region is shown in accordance with an illustrative embodiment. Specifically, input variance resolver 126 is configured with a special program configured to present Comparison Details 1400 inside fourth region 226. Fourth region 225 may also be referred to as Assessment Comparison Chart. Comparison Details 1400 are presented for a point on time line 1026 selected by time selection 1402 vertical line. Without limitation, selection of a time along time line 1026 may be activated by hovering a mouse pointer over a time along time line 1026. Time line 1026 is shown with time indexes for each market close, but may be programed for any time interval desired by a user. For any respective selected time along time line 1026, input variance resolver 126 is configured with a special program configured to present values derived for each of bid line 1028, offer line 1030, MOPL line 1032, and Interpolation line 1034 at the selected time.

Bid line 1028, offer line 1030, MOPL line 1032, and Interpolation line 1034 are shown as a nonlimiting example of markets presented in first region 214 listed from among My Markets 604 from which Input variance resolver 126 accepts data. Input variance resolver 126 may be programmed per a user preference to present lines and Comparison Details 1400 for a number of any of markets presented in first region 214 listed from among My Markets 604 from which Input variance resolver 126 accepts data.

The illustrations of graphical user interface in FIGS. 3-14 are provided as one illustrative example of an implementation for controlling a display of dynamic data updates and are not meant to limit the manner in which the display of dynamic data updates can be generated and presented in other illustrative examples. In one example, the viewport of graphical user interface 300 can be minimized, resized, or closed to enable viewing of other applications and hidden portions of graphical user interface 300.

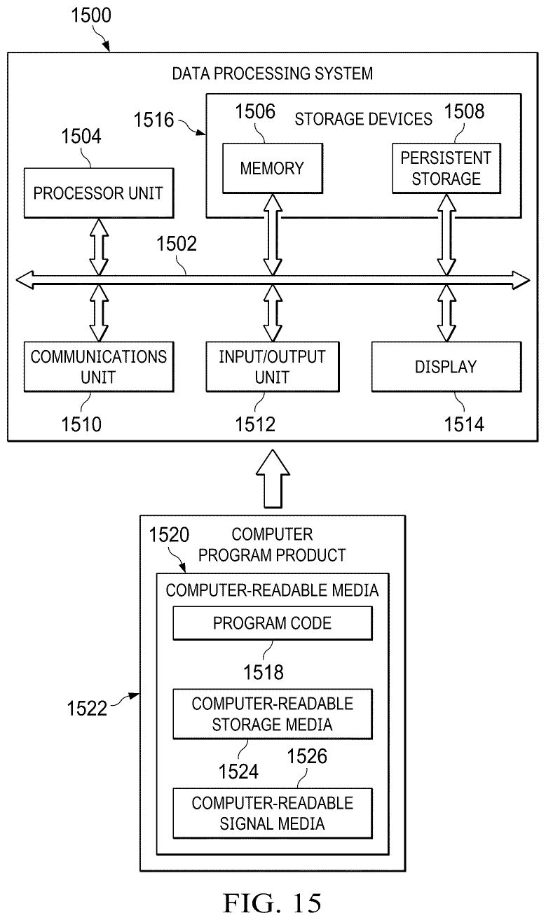

Turning now to FIG. 15, a block diagram of a data processing system is depicted in accordance with an illustrative embodiment. Data processing system 1500 can be used to implement server computer 104, server computer 106, client devices 110, in FIG. 1. Data processing system 1500 can also be used to implement computer system 130 in FIG. 2. In this illustrative example, data processing system 1500 includes communications framework 1502, which provides communications between processor unit 1504, memory 1506, persistent storage 1508, communications unit 1510, input/output (I/O) unit 1512, and display 1514. In this example, communications framework 1502 takes the form of a bus system.

Processor unit 1504 serves to execute instructions for software that can be loaded into memory 1506. Processor unit 1504 includes one or more processors. For example, processor unit 1504 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1504 may be implemented using one or more heterogeneous processor systems in which a main processor is present with secondary processors on a single chip. As another illustrative example, processor unit 1504 can be a symmetric multi-processor system containing multiple processors of the same type on a single chip.

Memory 1506 and persistent storage 1508 are examples of storage devices 1516. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1516 may also be referred to as computer-readable storage devices in these illustrative examples. Memory 1506, in these examples, can be, for example, a random-access memory or any other suitable volatile or non-volatile storage device. Persistent storage 1508 may take various forms, depending on the particular implementation.

For example, persistent storage 1508 may contain one or more components or devices. For example, persistent storage 1508 can be a hard drive, a solid-state drive (SSD), a flash memory, a rewritable optical disk, a rewritable magnetic tape, or some combination of the above. The media used by persistent storage 1508 also can be removable. For example, a removable hard drive can be used for persistent storage 1508.

Communications unit 1510, in these illustrative examples, provides for communications with other data processing systems or devices. In these illustrative examples, communications unit 1510 may be a network interface card.

Input/output unit 1512 allows for input and output of data with other devices that can be connected to data processing system 1500. For example, input/output unit 1512 may provide a connection for user input through at least one of a keyboard, a mouse, or some other suitable input device. Further, input/output unit 1512 may send output to a printer. Display 1514 provides a mechanism to display information to a user.

Instructions for at least one of the operating system, applications, or programs can be located in storage devices 1516, which are in communication with processor unit 1504 through communications framework 1502. The processes of the different embodiments can be performed by processor unit 1504 using computer-implemented instructions, which may be located in a memory, such as memory 1506.

These instructions are program instructions and are also referred are referred to as program code, computer usable program code, or computer-readable program code that can be read and executed by a processor in processor unit 1504. The program code in the different embodiments can be embodied on different physical or computer-readable storage media, such as memory 1506 or persistent storage 1508.

Program code 1518 is located in a functional form on computer-readable media 1520 that is selectively removable and can be loaded onto or transferred to data processing system 1500 for execution by processor unit 1504. Program code 1518 and computer-readable media 1520 form computer program product 1522 in these illustrative examples. In the illustrative example, computer-readable media 1520 is computer-readable storage media 1524.

In these illustrative examples, computer-readable storage media 1524 may be a physical or tangible storage device used to store program code 1518 rather than a medium that propagates or transmits program code 1518. Computer-readable storage media 1524, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. The term “non-transitory” or “tangible”, as used herein, may be a limitation of the medium itself (i.e., tangible, not a signal) as opposed to a limitation on data storage persistency (e.g., RAM vs. ROM).

Alternatively, program code 1518 can be transferred to data processing system 1500 using a computer-readable signal media. The computer-readable signal media are signals and can be, for example, a propagated data signal containing program code 1518. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media” can be singular or plural. For example, program code 1518 can be located in computer-readable media 1520 in the form of a single storage device or system. In another example, program code 1518 can be located in computer-readable media 1520 that is distributed in multiple data processing systems. In other words, some instructions in program code 1518 can be located in one data processing system while other instructions in program code 1518 can be located in one data processing system. For example, a portion of program code 1518 can be located in computer-readable media 1520 in a server computer while another portion of program code 1518 can be located in computer-readable media 1520 located in a set of client computers.

The different components illustrated for data processing system 1500 are not meant to provide architectural limitations to the manner in which different embodiments can be implemented. In some illustrative examples, one or more of the components may be incorporated in or otherwise form a portion of, another component. For example, memory 1506, or portions thereof, may be incorporated in processor unit 1504 in some illustrative examples. The different illustrative embodiments can be implemented in a data processing system including components in addition to or in place of those illustrated for data processing system 1500. Other components shown in FIG. 15 can be varied from the illustrative examples shown. The different embodiments can be implemented using any hardware device or system capable of running program code 1518.

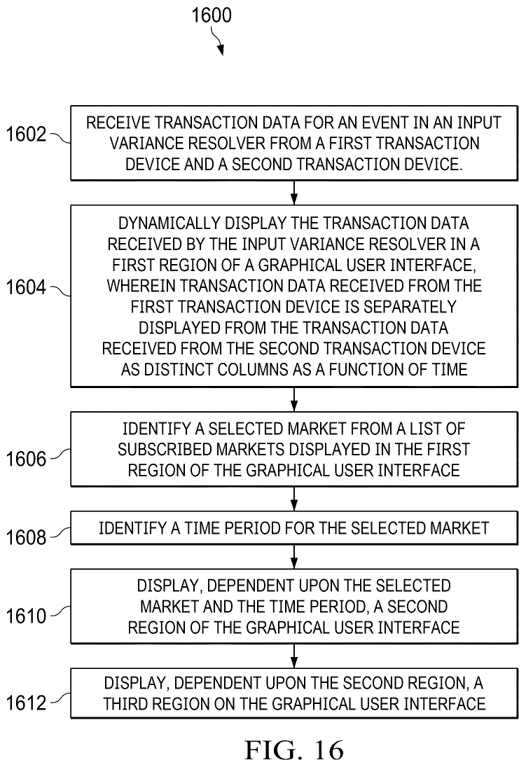

Turning next to FIG. 16, a flowchart of a process for controlling a display of dynamic data updates is depicted in accordance with an illustrative embodiment. The process in FIG. 16 can be implemented in hardware, software, or both. When implemented in software, the process can take the form of program code that is run by one or more processor units located in one or more hardware devices in one or more computer systems.

The process for controlling a display of dynamic data updates may include displaying an event on a graphical user interface, and may include at least: receiving transaction data for the event in an input variance resolver from a first transaction device and a second transaction device (operation 1602); dynamically displaying the transaction data received by an input variance resolver in a first region of the graphical user interface, wherein transaction data received from the first transaction device are separately displayed from the transaction data received from the second transaction device as distinct columns as a function of time (operation 1604); identifying a selected market from a list of subscribed markets displayed in the first region of the graphical user interface (operation 1606); identifying a time period for the selected market (operation 1608); displaying, dependent upon the selected market and the time period, a second region of the graphical user interface (operation 1610); and displaying, dependent upon the second region, a third region on the graphical user interface (operation 1612).

The process may also include: identifying a selected market from a list of subscribed markets displayed in a first region of the graphical user interface and identifying a time period for the selected market by the input variance resolver receiving a selection of a cell within the first region. The process may also include: displaying a range of time periods in the first region of the graphical user interface; receiving a selection of a specific time period displayed; and in response to the selection of the specific time period, dynamically updating the first region to display a subset of market participants that are active within the specific time period.

The process for controlling a display of dynamic data updates that may include displaying an event on a graphical user interface, may also include: receiving a selection of a first column of transaction data for the first transaction device, selected from the first region of the graphical user interface. The process may also include dynamically generating the second region using a selected cell from the first region; as well as displaying a first indicator in the third region indicating that the first transaction device has consummated a trade. The process may also include displaying, using the second region, a guardrail in the third region.

The process for controlling a display of dynamic data updates that may include displaying an event on a graphical user interface, may also include: the input variance resolver receiving a selection of a cell in the first region of the graphical user interface; and dynamically determining a spread within any of the transaction data associated with the cell. The process may also include the input variance resolver receiving a selection of a cell in the first region of the graphical user interface; and dynamically determining a normalization value for the transaction data associated with the cell, which may include the input variance resolver determining a guardrail for transaction data associated with a cell; and an alert rule communicating an alert when received data transaction for a cell contain data outside a guardrail, which may include registering the alert rule with a server-side rules engine, which may be included within program code within input variance resolver 126. Without limitation, the process may also include displaying, using the first region and the third region, a fourth region on the graphic user interface.

The flowcharts and block diagrams in the different depicted embodiments illustrate the architecture, functionality, and operation of some possible implementations of apparatuses and processes in an illustrative embodiment. In this regard, each block in the flowcharts or block diagrams may represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

Embodiments of a machine and process described herein may be represented by the following clauses:

Clause 1. A process for displaying an event on a graphical user interface, the process comprising:
receiving transaction data for the event in an input variance resolver from a first transaction device and a second transaction device;
dynamically displaying the transaction data received by an input variance resolver in a first region of the graphical user interface, wherein transaction data received from the first transaction device are separately displayed from the transaction data received from the second transaction device as distinct columns as a function of time;
identifying a selected market from a list of subscribed markets displayed in the first region of the graphical user interface;
identifying a time period for the selected market;
displaying, dependent upon the selected market and the time period, a second region of the graphical user interface; and
displaying, dependent upon the second region, a third region on the graphical user interface.

Clause 2. The process of clause 1, further comprising:
identifying a selected market from a list of subscribed markets displayed in a first region of the graphical user interface and identifying a time period for the selected market by the input variance resolver receiving a selection of a cell within the first region.

Clause 3. The process of clause 1, further comprising:
displaying a range of time periods in the first region of the graphical user interface;
receiving a selection of a specific time period displayed; and
in response to the selection of the specific time period, dynamically updating the first region to display a subset of market participants that are active within the specific time period.

Clause 4. The process of clause 1, further comprising:
receiving a selection of a first column of transaction data for the first transaction device, selected from the first region of the graphical user interface.

Clause 5. The process of clause 1, further comprising:
dynamically generating the second region using a selected cell from the first region.

Clause 6. The process of clause 1, further comprising:
displaying a first indicator in the third region indicating that the first transaction device has consummated a trade.

Clause 7. The process of clause 1, further comprising:
displaying, using the second region, a guardrail in the third region.

Clause 8. The process of clause 1, further comprising:
the input variance resolver receiving a selection of a cell in the first region of the graphical user interface; and
dynamically determining a spread within any of the transaction data associated with the cell.

Clause 9. The process of clause 8, further comprising:
the input variance resolver receiving a selection of a cell in the first region of the graphical user interface; and
dynamically determining a normalization value for the transaction data associated with the cell.

Clause 10. The process of clause 8, further comprising:
the input variance resolver determining a guardrail for transaction data associated with a cell; and
an alert rule communicating an alert when received data transaction for a cell contain data outside a guardrail.

Clause 11. The process of clause 10, further comprising:
registering the alert rule with a server-side rules engine.

Clause 12. The process of clause 1, further comprising:
displaying, using the first region and the third region, a fourth region on the graphic user interface.

Clause 13. A computer system that comprises:
a hardware processor;
a display system that comprises a graphical user interface; and
an input variance resolver configured to:
   communicate with the hardware processor and the display system; and
   control a display on a graphical user interface;
   receive transaction data from a first transaction device and a second transaction device;
   dynamically display the transaction data received by an input variance resolver in a first region of the graphical user interface, wherein transaction data received from the first transaction device are separately displayed from the transaction data received from the second transaction device as distinct columns as a function of time;
   identify a selected market from a list of subscribed markets displayed in a first region of the graphical user interface;
   identify a time period for the selected market;
   display, dependent upon the selected market and the time period, a second region of the graphical user interface; and
   display, dependent upon the second region, a third region on the graphical user interface.

Clause 14. The computer system of clause 13, wherein the input variance resolver is further configured to identify a selected market from a list of subscribed markets displayed in a first region of the graphical user interface and identifying a time period for the selected market by the input variance resolver receiving a selection of a cell within the first region.

Clause 15. The computer system of clause 13, wherein the input variance resolver is further configured to:
display a range of time periods in the first region of the graphical user interface;
receive a selection of a specific time period displayed; and
in response to the selection of the specific time period, dynamically update the first region to display a subset of market participants that are active within the specific time period.

Clause 16. The computer system of clause 13, wherein the input variance resolver is further configured to receive a selection of a first column of transaction data for the first transaction device, selected from the first region of the graphical user interface.

Clause 17. The computer system of clause 13, wherein the input variance resolver is further configured to dynamically generate the second region using a selected cell from the first region.

Clause 18. The computer system of clause 13, wherein the input variance resolver is further configured to display a first indicator in the third region indicating that the first transaction device has consummated a trade.

Clause 19. The computer system of clause 13, wherein the input variance resolver is further configured to display, based upon the second region, a guardrail in the third region.

Clause 20. A computer program product that comprises:
a computer readable storage media; and
program code, stored on the computer readable storage media, configured to display an event on a graphical user interface, and:
   receive transaction data from a first transaction device and a second transaction device;
   dynamically display the transaction data received by an input variance resolver in a first region of the graphical user interface, wherein transaction data received from the first transaction device are separately displayed from the transaction data received from the second transaction device as distinct columns as a function of time;
   identify a selected market from a list of subscribed markets displayed in a first region of the graphical user interface;
   identify a time period for the selected market;
   display, dependent upon the selected market and the time period, a second region of the graphical user interface; and
   display, dependent upon the second region, a third region on the graphical user interface.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments may include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A process for displaying an event on a graphical user interface, the process comprising:
receiving transaction data for the event in an input variance resolver from a first transaction device and a second transaction device;
dynamically displaying the transaction data received by an input variance resolver in a first region of the graphical user interface, wherein transaction data received from the first transaction device are separately displayed from the transaction data received from the second transaction device as distinct columns as a function of time;
identifying a selected market from a list of subscribed markets displayed in the first region of the graphical user interface;
identifying a time period for the selected market;
displaying, dependent upon the selected market and the time period, a second region of the graphical user interface; and
displaying, dependent upon the second region, a third region on the graphical user interface.

2. The process of claim 1, further comprising:
identifying a selected market from a list of subscribed markets displayed in a first region of the graphical user interface and identifying a time period for the selected market by the input variance resolver receiving a selection of a cell within the first region.

3. The process of claim 1, further comprising:
displaying a range of time periods in the first region of the graphical user interface;
receiving a selection of a specific time period displayed; and
in response to the selection of the specific time period, dynamically updating the first region to display a subset of market participants that are active within the specific time period.

4. The process of claim 1, further comprising:
receiving a selection of a first column of transaction data for the first transaction device, selected from the first region of the graphical user interface.

5. The process of claim 1, further comprising:
dynamically generating the second region using a selected cell from the first region.

6. The process of claim 1, further comprising:
displaying a first indicator in the third region indicating that the first transaction device has consummated a trade.

7. The process of claim 1, further comprising:
displaying, using the second region, a guardrail in the third region.

8. The process of claim 1, further comprising:
the input variance resolver receiving a selection of a cell in the first region of the graphical user interface; and
dynamically determining a spread within any of the transaction data associated with the cell.

9. The process of claim 8, further comprising:
the input variance resolver receiving a selection of a cell in the first region of the graphical user interface; and
dynamically determining a normalization value for the transaction data associated with the cell.

10. The process of claim 8, further comprising:
the input variance resolver determining a guardrail for transaction data associated with a cell; and
an alert rule communicating an alert when received data transaction for a cell contain data outside a guardrail.

11. The process of claim 10, further comprising:
registering the alert rule with a server-side rules engine.

12. The process of claim 1, further comprising:
displaying, using the first region and the third region, a fourth region on the graphic user interface.

13. A computer system that comprises:
a hardware processor;
a display system that comprises a graphical user interface; and
an input variance resolver configured to:
communicate with the hardware processor and the display system; and
control a display on a graphical user interface;
receive transaction data from a first transaction device and a second transaction device;
dynamically display the transaction data received by an input variance resolver in a first region of the graphical user interface, wherein transaction data received from the first transaction device are separately displayed from the transaction data received from the second transaction device as distinct columns as a function of time;
identify a selected market from a list of subscribed markets displayed in a first region of the graphical user interface;
identify a time period for the selected market;
display, dependent upon the selected market and the time period, a second region of the graphical user interface; and
display, dependent upon the second region, a third region on the graphical user interface.

14. The computer system of claim 13, wherein the input variance resolver is further configured to identify a selected market from a list of subscribed markets displayed in a first region of the graphical user interface and identifying a time period for the selected market by the input variance resolver receiving a selection of a cell within the first region.

15. The computer system of claim 13, wherein the input variance resolver is further configured to:
display a range of time periods in the first region of the graphical user interface;
receive a selection of a specific time period displayed; and
in response to the selection of the specific time period, dynamically update the first region to display a subset of market participants that are active within the specific time period.

16. The computer system of claim 13, wherein the input variance resolver is further configured to receive a selection of a first column of transaction data for the first transaction device, selected from the first region of the graphical user interface.

17. The computer system of claim 13, wherein the input variance resolver is further configured to dynamically generate the second region using a selected cell from the first region.

18. The computer system of claim 13, wherein the input variance resolver is further configured to display a first indicator in the third region indicating that the first transaction device has consummated a trade.

19. The computer system of claim 13, wherein the input variance resolver is further configured to display, based upon the second region, a guardrail in the third region.

20. A computer program product that comprises:
a computer readable storage media; and
program code, stored on the computer readable storage media, configured to display an event on a graphical user interface, and
receive transaction data from a first transaction device and a second transaction device;
dynamically display the transaction data received by an input variance resolver in a first region of the graphical user interface, wherein transaction data received from the first transaction device are separately displayed from the transaction data received from the second transaction device as distinct columns as a function of time;
identify a selected market from a list of subscribed markets displayed in a first region of the graphical user interface;
identify a time period for the selected market;
display, dependent upon the selected market and the time period, a second region of the graphical user interface; and
display, dependent upon the second region, a third region on the graphical user interface.
